(19) United States
(12) Patent Application Publication
(10) Pub. No.: US 2026/0322841 A1
(43) Pub. Date: Oct. 15, 2026

(54) DETECTION ENHANCEMENTS FOR THE IDENTIFICATION OF MALICIOUS ENTITIES OR COMPONENTS IN CLOUD ENVIRONMENTS

(71) Applicant: Darktrace Holdings Limited, Cambridge (GB)

(72) Inventors: Philip Sellars, Trumpington (GB); Andres Curto Martin, Cambridge (GB); Darragh Foley, Carlow (IE); Charlotte Gayton, Cambridge (GB); Joseph Gardner, Cambridge (GB); Norbert Toth, Cambridge (GB)

(21) Appl. No.: 19/575,090

(22) Filed: Mar. 23, 2026

Related U.S. Application Data
(60) Provisional application No. 63/775,808, filed on Mar. 21, 2025.

(51) Int. Cl. H04L 9/40

(52) U.S. Cl. CPC H04L 63/1425

(57) ABSTRACT

A cloud security system for providing comprehensive visibility and an in-depth understanding of a cloud environment, including creation or changes to cloud identities and cloud resources within the cloud environment, is described. The cloud security system features a cloud resource components configured to (i) collect the information, including properties and/or metrics, directed to the cloud resource, (ii) determine whether the cloud resources has have been created or modified recently, and if so, (iii) provide the information to at least a first pattern-of-life model configured to conduct an analysis as to whether the information deviates from a baseline of normal resource characteristics, and (iii) receive results of the analysis by the first pattern-of-life model to classify the cloud resource. The cloud security system further features components that collect properties and/or metrics directed to a cloud identity and determine recent malicious creation, modification or assumption of the identify using pattern-of-life modeling.

### RELATED APPLICATION

This application claims priority under 35 USC § 119 to U.S. Provisional Patent Application No. 63/775,808 entitled “CYBER SECURITY PROTECTION” filed on Mar. 21, 2025, where the entire content of this application is incorporated herein by reference in its entirety.

### NOTICE OF COPYRIGHT

A portion of this disclosure contains material that is subject to copyright protection. The copyright owner has no objection to the facsimile reproduction by anyone of the material subject to copyright protection as it appears in the United States Patent & Trademark Office's patent file or records, but otherwise reserves all copyright rights whatsoever.

### FIELD

Cyber security and embodiments of cloud environment analytics to gather information associated with cloud identities and cloud resources and conduct analytics to visualize cloud architectures and identify any anomalous or malicious efforts in the creation, modification or assumption of the cloud identifies and/or in the creation or modification of cloud resources.

### BACKGROUND

Cybersecurity attacks have become a pervasive problem for an enterprise (e.g., any organization including a company, a corporation, a partnership, individual or group of individuals, etc.) as enterprise networks and their networked devices are too frequently subjected to attack and compromise. A “cyber security threat” (sometimes referred to as a “cyber threat”) constitutes a threat to the security of a network and/or networked devices, such as creation, modification or assumption of credentials that may provide an attacker with access to an enterprise network and with an opportunity to initiate a cyberattack against the enterprise network or one or more cloud components within a cloud network accessible via the enterprise network. For example, the cyberattack may originate from an external source or an internal source (e.g., a negligent or rogue authorized user) through malicious creation, modification, and/or assumption of a cloud role (generally referred to as “cloud identity manipulation”) or through malicious creation and/or modification of a cloud component (generally referred to as “cloud resource manipulation”).

Cloud identity manipulation and cloud resource manipulation present an inherent security challenge because modern cloud environments grow quickly and unpredictably, creating sprawling sets of identities (roles, accounts, etc.) and cloud components (processing logic, storage logic, etc.)—many of them over-privileged or poorly understood. As a result, it becomes difficult to know which cloud identities and/or which cloud components should be provided access to sensitive information, and traditional security tools struggle to distinguish legitimate behaviors or actions from malicious behaviors or actions. Attackers exploit this confusion by assuming powerful roles, creating new cloud identities, or modifying cloud components (e.g., security groups, storage policies, firewall rules, identity policies such as Identity and Access Management “IAM” rules, etc.) to establish persistence, escalate privilege, or exfiltrate data—all while blending into normal cloud activity.

By providing components to detect and analyze unexpected identity creation, modification, and/or assumption along with anomalous cloud component creation or modification, a cybersecurity system would be able to better identify anomalous or malicious activities in order to mitigate cyber threats earlier than conventional techniques. In essence, the components may be adapted to turn cloud identity and configuration changes and attempted changes into behavioral signals, enabling rapid detection of threats like cloud ransomware, unauthorized persistence, or configuration backdoors long before log-based systems would raise an alert.

### SUMMARY

Methods, systems, and apparatus are disclosed for an Artificial Intelligence based (AI-based) enterprise security system. In general, the AI-based enterprise security system features a cloud security system integrated into (or communicatively coupled to) a cyber security appliance. According to one embodiment of the disclosure, deployed within a cyber security appliance or external therefrom, the cloud security system may be configured to collect (i) information pertaining to authorized identities (e.g., cloud roles, cloud accounts, cloud-based policies, etc.) and/or (ii) information pertaining to one or more components within a cloud environment utilized by an enterprise (hereinafter, “cloud resources”). The collection of the information associated with the cloud identities and the cloud resources may be extracted from one or more cloud networks via a corresponding cloud provider application programming interface (API) for example. Additionally, or in the alternative, information may be collected via sensors, logs, a specific cloud provider module, or the like. The cloud security system is configured to support security administrators by providing comprehensive visibility and an in-depth understanding of the enterprise's cloud environment, including creation or changes to cloud identities and/or cloud resources, within the cloud environment, within a prescribed period of time, such as from a time of collection.

According to one embodiment of the disclosure, the cloud security system (deployed within the cyber security appliance or external therefrom and in communication therewith) is configured with a cloud identity analytics component and a cloud resource analytics component. Herein, the cloud identity analytics component is configured to analyze recovered cloud identity information to determine whether any cloud identities (e.g., roles, accounts, etc.) may have been recently created, modified, or assumed. The privileges and permissions assigned to that assumed cloud identity (e.g., a privilege authorized within a prescribed period of time, such as from a time of collection, for that role can be assumed). When it is determined that the privileges and permissions assigned were changed or modified, then a determination is made of whether this cloud identity manipulation was performed for potential malicious purposes. Similarly, the cloud resource analytics component is configured to analyze recovered cloud resource information to determine whether any cloud resources (e.g., processing logic (EC2, Lambda functions, virtual machines, compute engines, etc.), storage logic (e.g., S3 buckets, Blob containers, cloud storage buckets, etc.), or the like) may have been recently created or modified, and if so, whether this cloud resource manipulation was performed for potential malicious purposes. The term “recent” may be construed within a prescribed period of time (e.g., an hour, day, week) or a period of time between the current time to a prior time in information collection and analysis (i.e., a prescribed period of time from the last time of collection).

The cloud identity analytics component and the cloud resource analytics component are configured to improve security administrator's understanding of the cloud environment operability and accessibility by different users. Such understanding further assists in (i) surfacing cyber threat risks by prioritizing cloud identity creations/changes or cloud resource creations/changes within the cloud architecture to investigate some cyber threat risks more urgently than others, and (ii) prioritizing the display of these prioritized cyber threat risks. The prioritization of certain cloud resource creations and/or modifications may be influenced by the criticality of the cloud resource as determined through a node centrality technique, a link prediction and evaluation technique, and/or a graph embeddings computational technique.

As described below, the cloud identity analytics component is configured to identify cloud identity manipulation that has occurred through the creation, modification, and/or assumption of cloud identities (e.g., cloud roles associated with a particular user, department, organization; cloud accounts associated with a particular user, department, organization, etc.) for malicious purposes. This may be detected through analysis of the gathered cloud identity information by pattern-of-life (POL) models to determine deviations from established cloud identity baselines (e.g., normal property/metrics for a particular cloud identity). The gathered cloud identity information may include content via flow logs, API(s), and/or scans of cloud architectures. Stated differently, the cloud identity analytics component may be configured to detect suspicious cloud identity manipulations based on deviations of the content from learned POL models associated with that cloud identity.

As an illustrative example, malicious cloud identity manipulation may be detected through one or more evaluations of selected properties and metrics from the gathered cloud identity information against expected properties and metrics for the identity (e.g., role for a user or group of users such as a team, department, or organization; account for a user or group of users, etc.). The selected properties and metrics may include, but is not limited or restricted to the following: (i) information for determining role duration, (ii) information associated with the number of role change (e.g., creation, modification or role-assumption) attempts (e.g., repetitive short-lived roles), (iii) information associated with the number of successful role changes, (iv) information associated with the number of failed role change (role-assumption attempts to escalate privileges relative to a user or role, (v) information associated with atypical user geolocation or time of activity, or the like. Additionally, or the alternative, the evaluations of selected properties and metrics may further include, at least in part, a determination of the role permissiveness, which may involve computation of a permissiveness score that is determined from a comparison of permitted actions to the total actions for a particular role, weighted by the importance of permission type.

The evaluation of one or more of the above-identified properties and/or metrics may be conducted against baseline values obtained through supervised machine learning (e.g., POL model(s)) to highlight potentially malicious role actions. Moreover, as an optional operation, the cloud identity analytics component may be configured to analyze chains of role assumption to find unusual patterns of repeated privilege escalation or role juggling through assumption of different roles that provide different access controls (e.g., privileges, permissions, etc.).

The cloud resource analytics component implements a cloud agnostic method to identify the creation and/or modification of cloud resources for malicious purposes by normalizing characteristics (properties and/or metrics) such as compute size, memory, region, runtime, and instance type across providers. The normalization assists in building a baseline of normal characteristics for certain cloud resources over time and across multiple cloud provider platforms. This enables the cloud resource analytics component to classify newly added or modified cloud resources as potentially malicious based on deviations from its baseline, which may be detected through distance and mean absolute deviation. This cloud agnostic method addresses attackers who spin up cloud resources for crypto mining, model training, data collection and exfiltration, or distributed denial-of-service (DDOS), in environments spanning Amazon Web Services (AWS®), Microsoft® Azure®, and Google Cloud Platform (GCP®).

The cloud resource analytics component and/or the cloud identity analytics component fill a gap where existing tools focus on configuration issues and lack cloud agnostic monitoring and techniques to better understand (and automatically prioritize for triage) cloud resources and/or cloud identities that are more critical to enterprise network security than others. These analytics components further provide faster incident response time due to proactive operability and real-time detection of non-compliance with network policies or of unexpected cloud resources. The analytics components also provide learning of normal fluctuations in organization cloud environments to better suppress false alerts that result in fatigue experienced by administrators in security operations center and increased costs realized in handling false alerts.

As an illustrative example, the cloud resource analytics component may be configured with a node centrality module that computes a “centrality score” representing the relative importance of a cloud resource within an enumerated cloud architecture. The centrality score is derived from graph-theoretic characteristics such as the number and type of incoming and outgoing connections, the resource's position within communication paths, and its connectivity to other highly connected resources. By evaluating these structural properties, a node centrality module identifies cloud resources whose compromise would be expected to have a disproportionately significant impact (e.g., ‘critical’) on the operation or security of the cloud architecture. As a result, the cloud resource analytics component can surface the most central resources, namely obtain information to identify the most ‘critical’ cloud resources based, at least in part, on egress and ingress connectivity where, if compromised, may cause the highest risks of migration across or adverse effects on the operability of the organization cloud environment. For these cloud resources, the cloud resource analytics component automatically raises or highlights such relevancy to the cloud user's or a security administrator's attention. This enables sub-architecture views of key nodes and edges on a graphical representation of cloud resources (e.g., cloud components) and communication paths with the organization cloud environment, to avoid overwhelming visualizations in cloud environments with thousands, tens, or hundreds of thousands of cloud resources.

Furthermore, the cloud resource analytics component may be configured to assist a cyber threat analyst module by indicating where a cloud resource resides within a cloud architecture and how interesting it is based on its centrality score. The cloud resource analytics component may be configured to assist one or more components in providing a visualization that allows advanced filtering to illustrate only cloud resources with a centrality score at or above a prescribed threshold to illustrate graphical nodes representing the cloud resources that would, if compromised, have the most significant impact on the health of the organization cloud environment.

The cloud resource analytics component may be further configured to operate in accordance with a link prediction and evaluation module to better understand (and automatically prioritize for triage) cloud resources that are critical to enterprise network security. The link prediction and evaluation module is configured to train a graph neural network (GNN) on cloud architectures, learning expected connections formed by controls, permissions, and access. The link prediction and evaluation module is adapted to find unexpected or missing links, thereby detecting an anomaly or potential misconfiguration to flag for investigation.

The cloud resource analytics component may be further configured to operate in accordance with graph-embedding techniques applied to cloud architectures. In this approach, a GNN generates low-dimensional vector representations of each cloud resource (node) and the architecture as a whole, capturing both local structural features and global contextual relationships. These graph embeddings enable the system to characterize the functional role of each cloud resource within the organization's cloud environment, identify outliers, cluster similar architectural patterns, and support downstream analytics such as anomaly detection, prioritization, and architecture-level comparisons. According to one embodiment of the disclosure, the cloud resource analytics component uses graph-level embeddings to measure similarities, cluster architectures, visualize organization, and predict outliers at deployment or at account level. These embedding-derived features, including anomaly scores, can be consumed by the cyber threat analyst module within the cyber security appliance or flagged directly to users.

These and other features of the design provided herein can be better understood with reference to the drawings, description, and claims, all of which form the disclosure of this patent application.

### BRIEF DESCRIPTION OF THE DRAWINGS

Embodiments of the invention are illustrated by way of example and not by way of limitation in the figures of the accompanying drawings, in which like references indicate similar elements and in which:

FIG. 1A illustrates an exemplary block diagram of a first embodiment of a cloud security system deployed to autonomously (a) interact with a organization cloud environment residing within cloud network(s) to identify cloud identities and/or cloud resources pertaining to the organization cloud environment and (b) interact with components of a cyber security appliance.

FIG. 1B illustrates an exemplary block diagram of a second embodiment of the cloud security system deployed within a cybersecurity provider managed (CP-managed) cloud environment.

FIG. 2 illustrates a block diagram of the general interactions between the cloud security system of FIG. 1A or FIG. 1B and both source content providers and output systems.

FIG. 3 illustrates a block diagram of a logical representation of a cloud identity analytics component and a cloud resource analytics component of the cloud security system of FIG. 1A or FIG. 1B.

FIG. 4 illustrates a block diagram of the cyber security system of FIG. 3 deployed within the cyber security appliance to determine cloud identity manipulation and/or cloud resource manipulation.

FIG. 5 illustrates a block diagram of a network system featuring cyber security system deployed within the cyber security appliance interacting with the organization cloud environment.

FIG. 6 illustrates a block diagram of a computing device that may be implemented with software in communication with the cyber security system inclusive of the cloud identity analytics component and the cloud resource analytics component of FIGS. 3-4.

While the design is subject to various modifications, equivalents, and alternative forms, specific embodiments thereof have been shown by way of example in the drawings and will now be described in detail. It should be understood that the design is not limited to the particular embodiments disclosed, but—on the contrary—the intention is to cover all modifications, equivalents, and alternative forms using the specific embodiments.

### DESCRIPTION

In the following description, numerous specific details are set forth, such as examples of components that are configured to conduct cloud identity and cloud resource analytics, exemplary deployment locations of such components, and other illustrative description in order to provide an understanding of aspects of the invention. It will be apparent, however, to one of ordinary skill in the art that one or more embodiments of the disclosure can be practiced in a manner different than these illustrative details. In other instances, well-known components or methods have not been described in detail in order to avoid unnecessarily obscuring the inventive aspects. Further, specific numeric references, such as a ‘first’ component for example, have been made. However, the specific numeric reference should not be interpreted as a literal sequential order but rather interpreted that the ‘first’ component may be different from a ‘second’ component.

As set forth herein, the specific details are merely exemplary and for illustrative purposes. Hence, the features implemented in one embodiment may be implemented in another embodiment where logically possible. The specific details can be varied from and still be contemplated to be within the spirit and scope of the present system or component configuration.

### 1. Terminology

In the following description, certain terminology is used to describe various features of the invention. For example, the terms “component,” “module,” and “logic” are functional elements that can be implemented as electronic circuits, software stored in a memory executed by one or more processors, and/or a combination of both. For instance, the component (or module or logic) may be representative of hardware and/or software configured to perform one or more functions. As hardware, a component (or module or logic) may include physical circuitry having data processing and/or storage functionality. Examples of such circuitry may include, but are not limited or restricted to a hardware processor (e.g., microprocessor with one or more processor cores, a digital signal processor, a graphics processing unit (GPU), a programmable gate array, a microcontroller, an application specific integrated circuit “ASIC,” etc.), a semiconductor memory, or combinatorial circuitry.

Alternatively, the component (or module or logic) may be software that includes code being one or more instructions, commands, or another data structure that, when compiled and/or processed (e.g., executed), perform a particular operation or a series of operations. Examples of software may include an application, a process, an instance, an Application Programming Interface (API), a routine, a subroutine, a plug-in, a function, an applet, a servlet, code, a script, a shared library/dynamic link library (dll), logical circuitry (e.g., logical functionality of certain physical circuitry), or even one or more instructions. This software may be stored in any type of a suitable non-transitory storage medium, or transitory storage medium (e.g., electrical, optical, acoustical, or other form of propagated signals such as carrier waves, infrared signals, or digital signals). Examples of non-transitory storage medium may include, but are not limited or restricted to a programmable circuit; non-persistent storage such as volatile memory (e.g., any type of random-access memory “RAM”); or persistent storage such as non-volatile memory (e.g., read-only memory “ROM,” power-backed RAM, flash memory, phase-change memory, etc.), a solid-state drive, hard disk drive, an optical disc drive, or a portable memory device. As firmware, the component (or module or logic) may be stored in persistent storage.

In general, the term “resource” generally relates to any logical or physical element that performs a specific task or function, which may be directed to managing security of a logical or physical network. For instance, a “cloud resource” may correspond to a logical element that performs a specific task or function within a cloud network. Examples of cloud resources may include, but are not limited or restricted to cloud-based components or services such as compute engines (e.g., AWS™ EC2, Azure® virtual machines, Google® compute engine, etc.), logical data stores (e.g., AWS™ S3, Azure® blob storage, etc.), firewalls, network-based units such as virtual private clouds (VPCs) or subnets, or the like.

The term “identity” is an object or element used to identify a construct that represents who or what is accessing resources so that access control systems can verify a user (e.g., individual, computing device, a group of users, a collection of computing devices, etc.) and determine what the user is allowed to do. Examples of an identity may include, but are not limited or restricted to a user account, a user role, a service account, and/or a collection of permissions or policies attached to the identity. Hence, a “cloud' identity” may be directed to a cloud account, a role of a user with access to a cloud network, a cloud service account, or the like.

The term “property” describes inherent characteristics of something such as an account, a role, a file size, etc. This data is typically static and constitute attributes of something. The term “metric” is a measure of behavior, performance, or activity over time. This data is often dynamic such as the number of failed role-assumption attempts, time of use, or the like. Herein, both properties and metrics may be generally referred to as “information” or “content,” namely a collection of information, whether in transit (e.g., over a network) or at rest (e.g., stored), often having a logical structure or organization that enables it to be classified for cyber-threat detection and prevention.

The term “computing device” should be generally construed as electronics with data processing capability and/or a capability of connecting to any type of network, such as a public network (e.g., Internet), a private network (e.g., a wireless data telecommunication network, a local area network “LAN,” etc.), or a combination of networks. Examples of a computing device may include, but are not limited or restricted to, the following: a server, a mainframe, a firewall, a router; or an endpoint device (e.g., a laptop, a smartphone, a tablet, a desktop computer, a netbook, gaming console, a wearable, etc.), or the like. The term “computing device(s)” denotes one or more computing devices.

The term “interconnect” may be construed as a physical or logical communication path between two or more computing devices or between different components. For instance, a physical communication path may include wired or wireless transmission mediums. Examples of wired transmission mediums and wireless transmission mediums may include electrical wiring, optical fiber, cable, bus trace, a radio unit that supports radio frequency (RF) signaling, or any other wired/wireless signal transfer mechanism. A logical communication path may include any mechanism that allows for the exchange of information between different components.

The term “message” generally refers to signaling (wired or wireless) as either information placed in a prescribed format and transmitted in accordance with a suitable delivery protocol or information made accessible through a logical data structure such as an API. Examples of the delivery protocol include, but are not limited or restricted to HTTP (Hypertext Transfer Protocol); HTTPS (HTTP Secure); Simple Mail Transfer Protocol (SMTP); File Transfer Protocol (FTP); iMESSAGE; Instant Message Access Protocol (IMAP); or the like. Hence, each message may be in the form of one or more packets, frame, or any other series of bits having the prescribed, structured format. The term “computerized” generally represents that any corresponding operations are conducted by hardware in combination with software or firmware.

The character set “(s)” denotes one or more elements. For example, the term “network(s)” denotes one or more networks. The term “component(s)” denotes one or more components. The term “model(s)” denotes one or more models, and the like.

Lastly, the terms “or” and “and/or” as used herein are to be interpreted as inclusive or meaning any one or any combination. Therefore, “A, B or C” or “A, B and/or C” mean “any of the following: A; B; C; A and B; A and C; B and C; A, B and C.” An exception to this definition will occur only when a combination of elements, functions, steps, or acts are in some way inherently mutually exclusive.

### II. General Architecture

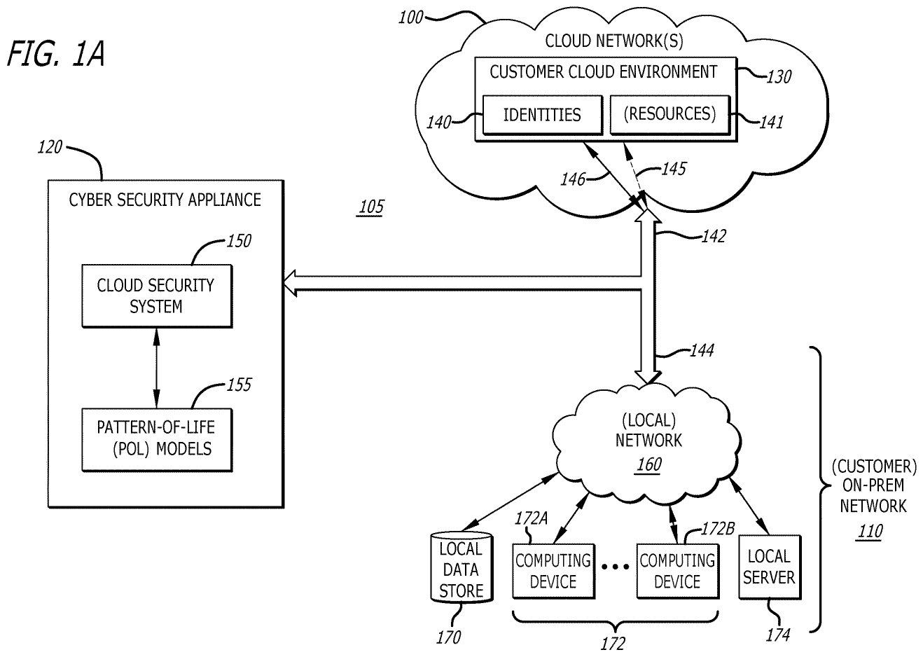

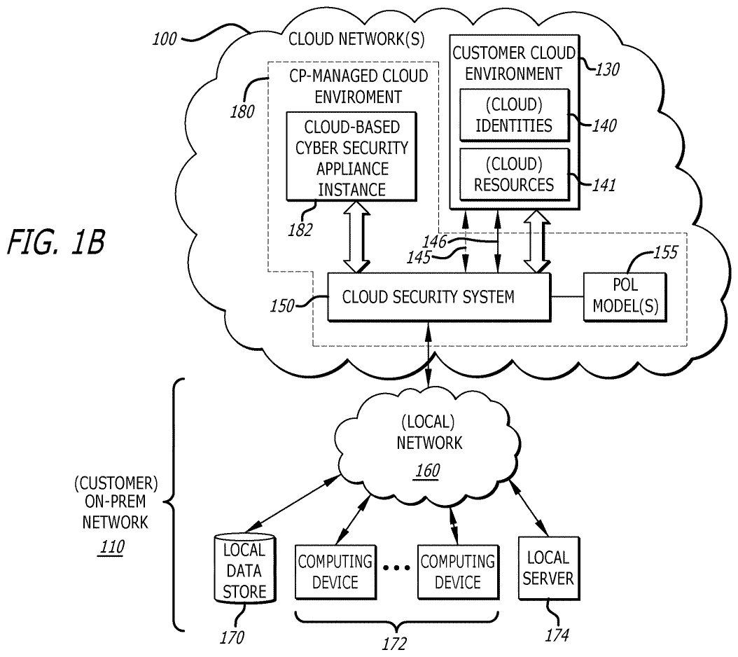

Referring to FIG. 1A, a block diagram of a first embodiment of a cloud security system 150 configured to operate with a organization cloud environment 130 deployed within one or more cloud networks 100 (hereinafter, “cloud network(s)” 100) and components of a cyber security appliance 120 is shown. Herein, the cyber security appliance 120 may be hosted in a organization on-premises (“on-prem”) network 110 (or external therefrom). The cloud security system 150 may be hosted internally within the cyber security appliance 120 or separately therefrom, where the cyber security appliance 120 may be located within or outside the on-prem network 110.

The cloud security system 150 may be configured to autonomously interact with the cloud network(s) 100 to determine cloud identities 140 associated with a organization cloud environment 130 that may have been created, modified or assumed for malicious purposes. Similarly, the cloud security system 150 may be configured to autonomously interact with the cloud network(s) 100 to determine cloud resources 141 (cloud components and/or cloud architectures) associated with the organization cloud environment 130 that may have been created or modified for malicious purposes. To determined potential malicious purpose, the cloud security system 150 is configured to interact with one or more pattern-of-life (POL) models 155 (hereinafter, “POL model(s)”), which analyzes properties and/or metrics associated with the cloud identity (e.g., roles, accounts, etc.) or the cloud resource (e.g., compute engine, virtual machine, etc.) against normal (or expected) properties and/or metrics. These analyses, when performed, are utilized to identify deviations, and thus, potential cyber threats. The results from the POL model(s) 155 may be returned to the cloud security system 150, which may initiate messaging to modules within the cyber security appliance 120 and/or computing devices within the on-prem network 110 to purposefully display the most critical cyber threats to improve network security triage.

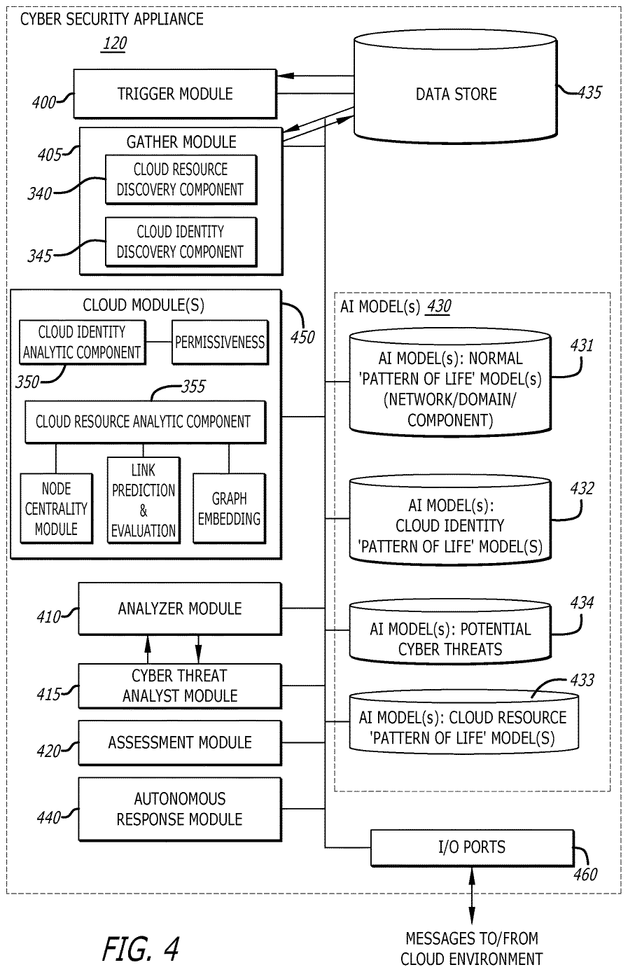

In particular, according to one embodiment of the disclosure, the cloud security system 150 may be pre-configured to communicate with the cloud network(s) 100 and the cyber security appliance 120. Collectively, the cyber security appliance 120 and the cloud security system 150 operate as a security system for an enterprise, where components forming the cloud security system 150 are deployed as part of module(s) within the cyber security appliance 120 as shown in FIG. 4.

As another embodiment, as shown in FIG. 1B, functionality associated with the cloud security system 150 and the cyber security appliance 120 of FIG. 1A may be hosted in a cybersecurity provider managed (CP-managed) cloud environment 180, where the cloud security system 150 is in communication with the organization cloud environment 130. Herein, the cloud security system 150 may be configured as a cloud service that autonomously (a) interacts with components of the cloud network(s) 100 to determine the cloud identities 140 and/or the cloud resources 141 associated with the organization cloud environment 130 and (b) interact with a cyber security appliance instance 182 to perform analytics on the cloud identities 140 and/or the cloud resources 141 to identify potential cyber threats.

As yet other embodiments of the disclosure, although not shown, the cloud security system 150 may be deployed as part of the on-prem network 110 interacting with cloud network(s) 100 to identify cloud identities 140 and/or cloud resources 141 within the organization cloud environment 130 created or modified for malicious purposes. For this embodiment, the cloud security system 150 may be communicatively coupled to, but separate from, the cyber security appliance 120 and/or the cyber security appliance instance 182.

More specifically, as shown in FIG. 1A, the cloud security system 150 is configured to autonomously interact with the organization cloud environment 130 maintained with the cloud network(s) 100 via interconnect 142. Herein, the cloud security system 150 is configured to identify cloud identities 140 utilized by the organization cloud environment 130 and access metadata 145 associated with the cloud identities 140. Similarly, the cloud security system 150 is configured to identify cloud resources 141 utilized by the organization cloud environment 130 and access metadata 146 associated with the cloud resources 141. The metadata 145 associated with the cloud identities 140 may include access controls (e.g., role information, policies including permissions, account information, etc.) associated with a user (e.g., individuals(s), computing device(s), etc.), while the metadata 146 associated with the cloud resources 141 may include cloud-based components and/or services associated with the organization cloud environment 130. Both the cloud identities 140 and the cloud resources 141 are maintained within the cloud network(s) 100 operating as a part of a public cloud network. Alternatively, the cloud network(s) 100 may operate as one or more private cloud networks accessible to the organization.

Additionally, the cloud security system 150 is configured to identify the cloud resources 141 or a subset of the cloud resources 141 to provide a visualization of the organization cloud environment 130 to computing devices residing at the on-prem network 110. Furthermore, in combination with the POL model(s) 155, the cloud security system 150 is configured to perform analytics on information (e.g., the metadata 145 including properties and/or metrics associated with the cloud identities 140 and/or the metadata 146 including properties and/or metrics associated with the cloud resources 141) to identify potential cyber threat risks thereof. The metadata 145/146 may be used to determine cyber threat risk by conducting analytics of at least portions of the metadata 145/146, using the POL model(s) 155 within the cyber security appliance 120, to identify cloud identity manipulation(s) and/or cloud resource manipulation(s) that are potentially malicious.

As further shown in FIGS. 1A-1B, the on-prem network 110 features a local network 160 that enables communications between a number of computing devices such as a local data store 170, one or more computing devices 172, and/or a local server 174. Consequently, all of the computing devices 172 are able to access the local server 174 and content within the local data store 170. According to this embodiment of the disclosure, the cloud security system 150 is coupled to both the local network 160 and to the cloud network(s) 100 via interconnects, such as interconnects 142 and 144 of FIG. 1A for example.

The cyber security appliance 120 may be a component residing outside or even inside the on-prem network 110 as shown or may be implemented as part of any or all of the computing devices 172. For this illustrative example, where functionality of the cyber security appliance 120 is deployed within a first computing device 172A, including electronic hardware, modules, models, and various software processes of the cyber security appliance 120, the first computing device 172A runs threat detection for detecting cyber threats pertaining to the organization cloud environment 130. As such, the first computing device 172A includes one or more processors arranged to run the operations of the process described herein, memory storage components required to store information related to the running of the process, as well as network interfaces for collecting and acquiring information from the cloud security system 150 and/or any probes or other sensors collecting data from the network under analysis.

Referring still to FIG. 1A, the cyber security appliance 120 is configured to build and maintain dynamic, ever-changing POL models with operational “baselines” established for each cloud identity (e.g., each user being an individual, computing device, a group of individuals, etc.), each cloud resource (e.g., each computing device being a compute engine, logical storage device, virtual machine, etc.), or a combination thereof. Using a Bayesian approach, the cyber security appliance 120 is adapted to monitor interactions, events, and communications within the organization cloud environment 130 (e.g., communications involving cloud identities 140, cloud resources 141 associated with the organization cloud environment 130, metadata 145/146 inclusive of metrics and/or properties associated with newly created/modified/assumed cloud identities 140 and/or newly created/modified cloud resources 141.

For example, the computing device 172B or one of the cloud resources 141 may be based in the West Coast and is operated by a marketing employee who regularly accesses the marketing network, usually communicates with physical (computing device 172A) or logical (cloud resource 141) devices between 9:30 a.m. and midday, and is active from around 8:30 a.m. until 6 p.m. The same employee does not have access to the employee timesheets, rarely connects to the company's VLAN network as represented by local server 174, and has no dealings with Southeast Asia. The cyber security appliance 120 takes all the information that is available relating to the employee and establishes a “pattern-of-life” (baseline using AI-based POL model(s) 430 of FIG. 4) for that person and for the physical and/or logical devices used by that person in that system which is dynamically updated as more information is gathered. Therefore, any unusual cloud identity manipulation (e.g., creation, assumption, or manipulation of a role with certain access privileges) or cloud resource manipulation (e.g., creation or manipulation of a cloud resource), such as the access of local server 174, may be detected through analytics including POL model analysis.

The AI modeling of the normal pattern-of-life for an entity (e.g., an identity such as a user representing a person, a computing device, etc.) in a network under analysis may be used as a moving benchmark, allowing the cyber security appliance 120 to spot actions on the enterprise system 105 requiring further investigation and/or potential autonomous action. This may occur when the monitored action(s) or behavior(s) fall outside of the normal actions or behaviors applied by POL models to denote that the monitored action(s) is anomalous. This monitored behavior may involve cloud identity manipulation and/or cloud resource manipulation. The ‘cloud identity manipulation’ behaviors, which may be based on a user or a computing device activities that create, modify, or assume a user's role (e.g., privileges, permissions, policies, etc.), are evaluated in association with POL models directed to expected operability and the risks associated with such operability. The ‘cloud resource’ behaviors, which may be based on user or computing devices activities that create or modify cloud resources (e.g., EC2, VMs, S3, etc.) are evaluated in association with POL models directed to expected cloud resource presence. These evaluations are useful in producing a ranking of different cloud identity manipulations and/or cloud resource manipulations to assist in prioritizing further investigation and/or remediation actions.

Referring now to FIG. 1B, a block diagram of a second embodiment of the cloud security system 150 deployed within the CP-managed cloud environment 180 is shown in lieu of being deployed external from the organization cloud environment 130 (and optionally within the cyber security appliance 120 as shown in FIG. 1A). Herein, the cloud security system 150 is configured to autonomously determine the cloud identities 140 and/or the cloud resources 141 within the cloud environment 130 and access the POL model(s) 155 associated with the cloud identities 140 and/or the POL model(s) 155 associated with the cloud resources 141. Although not shown, the POL model(s) 155 may be placed in cloud storage.

Differing from FIG. 1A, as shown in FIG. 1B, the cyber security appliance 120 may be deployed as an instance 182 within the cloud network(s) 100 accessible by the organization. Herein, the cloud security system 150 is adapted to interact with the organization cloud environment 130 in order to ascertain cloud identities 140 (e.g., roles for each entity ranging from individual users to user groups, departments, or companies, accounts, etc.) and/or cloud resources 141. Thereafter, the POL model(s) 155 may be accessed for use to determining cyber threats and vulnerabilities, where visualizations may be generated to better illustrate the most ‘critical’ cyber threats (e.g., cyber threats with the highest likelihood of migration, highest likelihood of damage to the network, etc.) and highlight the ‘critical’ cyber threats. These visualizations enable administrators to conduct actions with better clarity as to on-going cyber threats to mitigate such cyber threats.

For example, the cloud security system 150 may be configured to access POL model(s) 155 to analyze properties and/or metrics associated with newly created, modified or assumed cloud identities and/or any newly created or modified cloud resources 141 and generate an assessment from the POL model(s) 155 as to cyber threat risks associated with the created or changed cloud identity and/or cloud resource. With this assessment (result), the cloud security system 150 may be configured to initiate the generation of one or more visualizations of the cloud architectures and render these visualizations for display and review by a security administrator. The visualizations may be adapted to provide a better and more effective triage ranking for the cyber threats based on a holistic threat level (e.g., consideration of the persuasiveness as to migration, harm to the cloud network(s) caused by a cyberattack pertaining to the detected cyber threat, etc.).

### III. General Functionality of the Cloud Security System

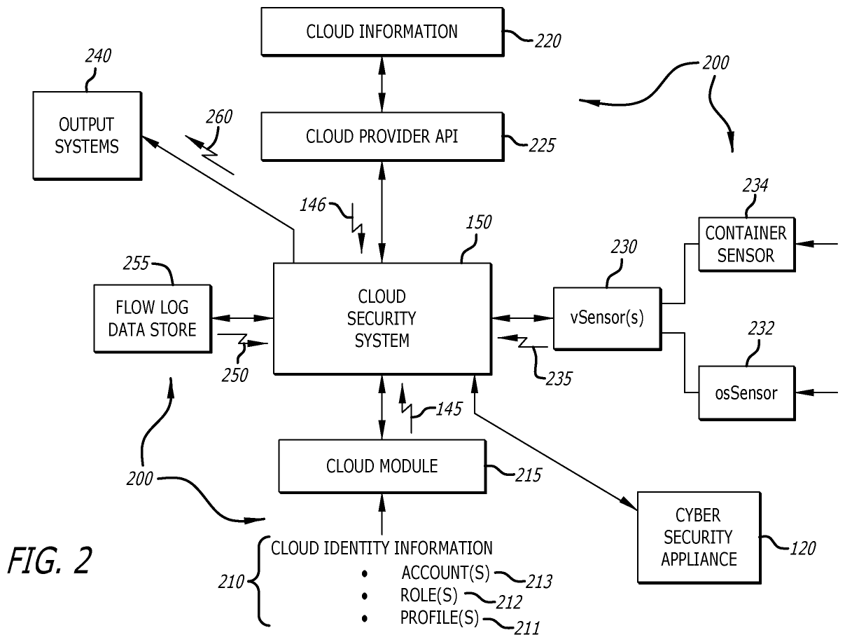

Referring to FIG. 2, a block diagram of the general interactions between the cloud security system 150 of FIG. 1A or FIG. 1B as well as a plurality of content providers 200 and output systems 240 is shown. Herein, as described above and illustrated in FIG. 1A and/or FIG. 1B, the cloud security system 150 is configured to ingest data from different sources, including (i) cloud identity information 210 and (ii) cloud resource information 220 obtained via a cloud provider API 225. The cloud identity information 210, corresponding to the metadata 145 of FIGS. 1A-1B received via a cloud module 215 (e.g., AWS module), includes one or more properties and/or metric(s) associated with the cloud identities 140 (e.g., user profile information 211, user role information 212, user account information 213, etc.). The cloud resource information 220, corresponding to the metadata 146 of FIGS. 1A-1B, includes one or more properties and/or metric(s) associated with the cloud resources 141.

Additionally, the cloud security system 150 is configured to ingest network traffic data 235 from vSensors 230 as provided by hosted agents (osSensors 232, container (Kubernetes) sensors 234, etc.), and/or log data 250 (e.g., flow logs and/or audit logs to track identity-based behaviors maintained in a flow log data store 255).

In particular, the cloud security system 150 is configured with components to perform a number of operations on the ingested data. Some of these operations may include, but are not limited or restricted to the following: (1) cloud resource discovery, (2) cloud identity discovery, (3) cloud identity analytics directed to compliance with historical identity characteristics to assist in determination as to whether creation, modification and/or assumption of a cloud identity (e.g., role or account) is malicious or not and/or cloud architecture generation and rendering, (4) cloud resource analytics directed to compliance with historical cloud architectures to identify the creation or modification of a cloud resource is malicious or not, and/or cloud architecture generation and rendering.

As shown in FIG. 2, the cloud security system 150 is communicatively coupled to the output systems 240. More specifically, after conducting operations on the ingested data, the cloud security system 150 may be configured to provide one or more messages 260 to the output systems 240, where the messages 260 may constitute notifications, display message signaling (e.g., Slack® messages, chat messages over a video-conferencing platform, graphical signaling for rendering cloud architecture representations, etc.), or even a “support” or “help” message (e.g., GitLab or ServiceNow ticket). Additionally, or in the alternative, the cloud security system 150 may further be coupled to the cyber security appliance 120 to leverage the AI modeling, autonomous response, and other modules in order to identify and tackle potential cyber threats associated with cloud identity manipulation and/or cloud resource manipulation.

### IV. Embodiments of the Cloud Security System/Functions

### A. Cloud Security System—First Embodiment

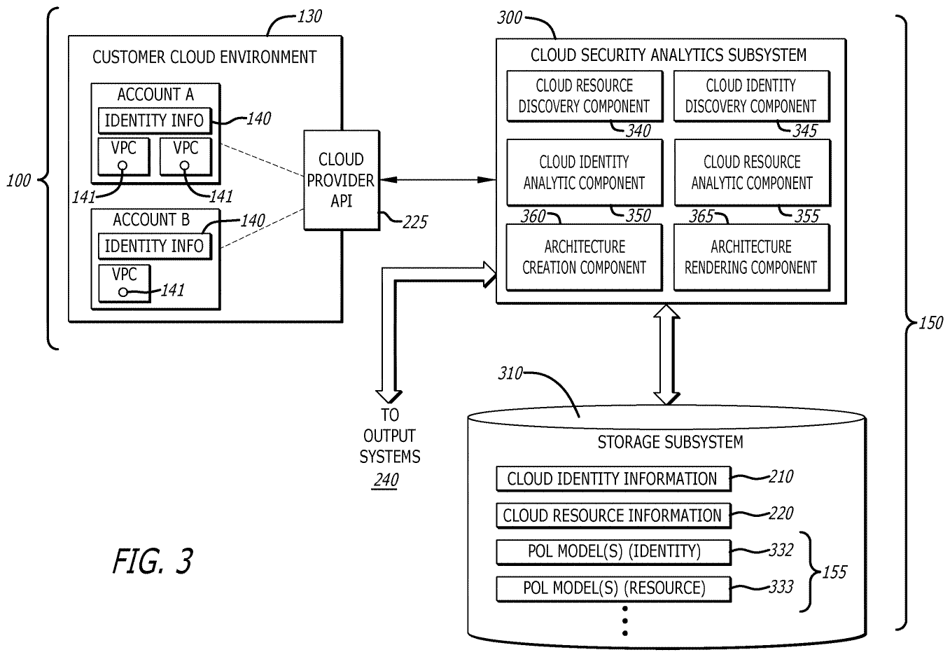

Referring now to FIG. 3, a block diagram of an exemplary logical representation of the cloud security system 150 is shown, where the cloud security system 150 is configured to, among other things, (i) determine cloud identities and/or resources, (ii) populate a local storage subsystem 310 with the cloud identity information 210 (e.g., one or more properties and/or metric(s) associated with the cloud identities 140) and/or the cloud resource information 220 (e.g., one or more properties and/or metric(s) associated with the cloud resources 141), (iii) conduct analytics of the cloud identity information 210 prior to transmission to pattern-of-life (POL) model(s) for analysis of one or more cloud identities as to whether its creation, modification or assumption of permissions/privileges is potentially malicious and constitutes a cyber threat, (iv) conduct analytics of the cloud resource information 220 prior to transmission to POL model(s) for analysis of one or more cloud resources as to whether its creation or modification is potentially malicious and constitutes a cyber threat, and (v) assist in generating visualizations of cloud architectures after receipt of the POL model(s) analysis results to identify and rank potential cyber threats. Herein, the cloud security system 150 features a cloud security analytics subsystem 300 and the storage subsystem 310, where the cloud security system 150 may be configured as part of the cloud appliance, part of the organization cloud environment, part of the on-prem network, or any combination thereof.

According to one embodiment, as shown, the storage subsystem 310 may be configured as one or more local data stores. The local data store(s) may be configured to maintain the POL model(s) 155, each POL model may be associated with different cloud identities at different levels of analysis. For example, POL model(s) 332 may feature one or more POL models for analysis of cloud identities while POL model(s) 333 may feature one or more POL models for analysis of cloud resources. The POL model(s) 332-333 are referenced as POL models 432-433 in FIG. 4, given their deployment in the cyber security appliance 120.

As an illustrated embodiment, one of the POL models 332 may be directed to conducting an analysis of properties and/or metrics associated with a cloud role for a particular user (where the user may be an individual, group of individuals, company, computing device, collection of computing devices, etc.) against expected properties and/or metrics for that cloud role. Another one of the POL models 332 may be directed to conducting an analysis of properties and/or metrics associated with a particular user account (where the user is an individual, group of individuals, company, department within a company, etc.) against expected properties and/or metrics for that account.

Additionally, the local data store(s) may be configured to maintain POL model(s) 333 associated with the cloud resources. For example, one of the POL models 333 may be directed to conducting an analysis of properties and/or metrics associated with a first type of cloud resource (e.g., compute engine) against expected properties and/or metrics for that type of cloud resource. Likewise, another one of the POL models 333 may be directed to conducting an analysis of properties and/or metrics associated with a second type of cloud resource (e.g., virtual machine) against expected properties and/or metrics for virtual machines.

Furthermore, as shown in FIG. 3, the storage subsystem 310 may include a data store to maintain the cloud identity information 210 for one or more selected levels of users such as per individual, per groups of individuals, per department, per division, per company, per computing device, or the like. The cloud identity information 210 may include properties and/or metrics from role-based content such as role duration (e.g., identify repetitive short-lived roles), the number of role-assumption (role change) attempts, the number of failed role-assumption attempts for the entity, cloud account identifier, user geolocation or time of activity. The POL model(s) 332 analyze these properties and/or metrics, which may include a correlation determination of the properties and/or metrics with baseline (expected) values, to uncover anomalies associated with a newly created, modified or assumed cloud identity.

The storage subsystem 310 may further include a second data store to maintain the cloud resource information 220 (e.g., resource name, resource size, resource configuration type (e.g., EC2, Lambda, etc.), origin or geolocation, age, naming convention, or optional information such as the number and length of role chain metrics, etc.). The POL model(s) 333 is configured to analyze the properties and/or metrics of the cloud resource information 220 by conducting a correlation determination with baseline (expected) values to uncover anomalies pertaining to the newly created or modified cloud resource to which the cloud resource information 220 pertains.

According to one embodiment of the disclosure, the cloud security analytics subsystem 300 is communicatively coupled to the organization cloud environment 130 accessible via a cloud provider API 225 to access and collect information associated with newly created or modified cloud identities 140 and/or cloud resources 141 as well as to communicate with POL model(s) associated with the cloud identities 140 and/or the cloud resources 141.

Although not shown in detail, the cloud security analytics subsystem 300 may be communicatively coupled to output systems 240 to provide messages as notifications, chat messages, or tickets to request activity by a particular service provider. Also, the cloud security analytics subsystem 300 may be communicatively coupled to one or more modules within the cyber security appliance 120 to leverage the AI modeling, autonomous response, and functionality in order to identify and tackle potential cyber threats.

According to this embodiment of the disclosure, the cloud security analytics subsystem 300 features a cloud resource discovery component 340, a cloud identity discovery component 345, a cloud identity analytics component 350, a cloud resource analytics component 355, an architecture creation component 360, and/or an architecture rendering component 365. These components 340-365 may be configured to operate concurrently in which cloud identities and/or cloud resources are analyzed for potential malicious intent in their creation or modification and cloud architectures are generated based on information associated with the cloud resources uncovered by the cloud resource discovery component 340.

As shown in FIG. 3, according to one embodiment of the disclosure, the cloud resource discovery component 340 is configured to identify cloud resources 141 that exist within the organization cloud environment 130, notably newly created or modified cloud resources. More specifically, the cloud resources 141 may be identified by recovering the cloud resource information 220, namely the properties and/or metric(s) directed to one or more logical components that perform a specific task or function within the cloud network (e.g., cloud resources). Examples of the cloud resources may include, but is not limited or restricted to compute engine(s) (e.g., AWS™ EC2, Azure® Azure® virtual machines, Google® compute engine, etc.), logical data store(s) (e.g., AWS™ S3, Azure® blob storage, etc.), virtual private cloud(s) (VPC(s)), virtual machine(s) (VM(s)), or the like. The cloud resource information 220 associated with each of the identified cloud resources is collected, categorized, and provided to the storage subsystem 310.

According to this embodiment, the cloud resource discovery component 340 may be further configured to conduct access mapping operations by determining what cloud resources have access to other resources. This analysis may involve an evaluation of the cloud resource information 220, where the evaluation may be conducted by search logic to identify communications paths between cloud resources (hereinafter, “access paths”). Additionally, the cloud resource discovery component 340 may be configured to conduct network mapping operations by performing analytics of the network-based cloud resources (e.g., VPCs, subnets, etc.) as well as the network policies to determine communication paths for these network-based cloud resources (hereinafter, “network paths”).

According to one embodiment of the disclosure, as further shown in FIG. 3, the cloud identity discovery component 345 is configured to determine and collect the cloud identity information 210, which includes properties and/or metrics associated with cloud identities, inclusive of cloud identities that have been created, modified, or assumed since the last evaluation (e.g., timestamp technology may be used in such identification). These cloud identities may pertain to roles (e.g., user role or group of user roles for permission/privilege insight for resource accessibility) and/or cloud account(s) such as changes in account characteristics such as password changes, disable certain functionality, changes to recovery contact information, changes to permissions associated with the account holder, or the like. The cloud identity information 210 may further include other information associated with a user of the enterprise system including a user profile (that may be misused for identity monitoring), a digital certificate (misused for user authentication and access controls), or the like.

As further shown in FIG. 3, the cloud identity analytics component 350 is configured to interact with the AI-based POL model(s) 332 to perform analytics on the cloud identity information 210 recovered by the cloud identity discovery component 345. The analytics may be directed to identifying which, if any, cloud identities (roles, accounts, profiles, etc.) have been created, modified, and/or assumed for potential malicious purposes. In general terms, the cloud identity analytics component 350 is configured to determine how one or more cloud identities are behaving within the organization cloud environment 130 and solicit POL modeling analysis for those cloud identities that are suspicious.

In particular, the cloud identity analytics component 350 and/or POL model(s) 332 may be configured to conduct analyses of log data and network traffic data in light of access controls (e.g., user/group privileges, user/group permissions, policies, etc.). For example, the cloud identity analytics component 350 may perform identity monitoring by conducting analytics on audit logs to learn which cloud identity (e.g., user, computing device, account, etc.) is accessing the cloud resources. Such monitoring may cause the cloud identity analytics component 350 to submit properties and/or metrics associated with that cloud identity to the POL model(s) 332 for further analysis. The cloud identity analytics component 350 may further perform enhanced identity monitoring by analyzing user roles to better understand privileges and insights into resource accessibility.

The cloud resource analytics component 355 is configured to interact with the AI-based POL model(s) 333 to perform analytics on the recovered cloud resource information 220 to determine whether the creation and/or modification of that particular cloud resource may have been for potentially malicious purposes. This determination may be accomplished through comparison of resource information (e.g., captured properties and/or metrics) to pattern-of-life baselines associated that particular resource. Examples of different types of resource information for pattern-of-life modeling comparison includes, but is not limited or restricted to any combination of the following:
(i) resource compute size or capacity, (ii) resource configuration, (iii) resource type, (iv) resource naming convention, (v) ephemeral resource lifecycles that may include spin-up frequency, duration, and/or timing of activation, and/or (vi) resource location. The comparison may include two of the resource information types, three of the resource information types, or at least five of the resource information types.

Improved understanding of the interaction of cloud resources assists in (i) identifying the priority of the cloud resource within the cloud architecture and (ii) prioritizing the display of the cloud resources may be accomplished through various techniques to highlight the ‘criticality’ of the cloud resource. Such criticality determination may be accomplished through a node centrality technique, a link prediction and evaluation technique, and/or a graph embeddings computational technique as described below. The ‘criticality’ of the cloud resource may adjust a weighting applied to a classification of the cloud resource under analysis as “malicious” or “benign,” where a higher criticality determination may lower a threshold applied to an analysis result from the POL model(s) 333 in the cloud resource analytics component's determination whether the cloud resource is malicious, and a lower criticality determination may increase the threshold.

Referring still to FIG. 3, the architecture creation component 360 is configured to determine cloud architecture (constructs) that represent a set (two or more) of the enumerated cloud resources in communication and associated with a unified purpose. The formation of the cloud architectures may be based on inter-resource relationships between the cloud resources determined by the cloud resource discovery component 340 as well as access controls associated with the cloud resource. The architecture rendering component 365 is configured to generate graphical representations of the created cloud architectures as determined by the architecture creation component 360, where edge lines are used to represent relationship and communications between cloud resources represented as graphical nodes.

In summary, the cloud resource discovery component 340 operates in combination with the cloud resource analytics component 355 and the cloud identity discovery component 345 operates in combination with the cloud identity analytics component 350 is shown. More specifically, as a first operation, the cloud resource discovery component 340 is configured to detect when new cloud resources are created (spun-up) and existing cloud resources are modified by collectively analyzing one or more logs (e.g., flow logs, management trail logs, etc.), events gathered via APIs, and scans to determine changes in the cloud infrastructure diagrams. In general terms, the cloud resource discovery component 340 tracks new or altered cloud resources in environments where frequent spin-up and tear-down are normal, focusing on atypical resource activity.

After discovery of the new or modified cloud resource, as a second operation, the cloud resource analytics component 355 is configured to gather certain properties and metrics associated with newly created or modified cloud resource, where the properties and metrics may include compute size, memory or sizing parameters, naming convention for the cloud resource, timing of the creation or modification event, and/or resource configuration options. The cloud resource analytics component 355 may be further configured to filter noise by discounting outlying values consistent with a cloud resource developer's typical pattern of activity.

Thereafter, as a third operation, the cloud resource analytics component 355 is configured to provide the collected properties and/or metrics to the POL model(s) 333. The POL model(s) 333 conducts an analysis of the collected properties and/or metrics against established norms (baseline) for resource provisioning and resource activity within the organization cloud environment. The POL model(s) 333 can be formulated at several levels of analysis: individual user, account, organization, and for the cloud resource itself. The properties and/or metrics of the new or modified resource are compared to the established baselines to assess potential anomalous or suspicious activity.

Operating as a classifier, as shown as a fourth operation, the cloud resource analytics component 355 uses the gathered characteristics (properties and/or metrics) and AI results from the POL model(s) 333, including the anomalous deviation(s) for one or more properties and/or metrics determined by the POL model(s) 333, to determine a likelihood that the cloud resource under analysis is potentially malicious or benign. Where the cloud resource is deemed to be potentially malicious, the cloud resource analytics component 355 may be configured to initiate further security analysis or automated response actions and generate a graphical representative identifying the most ‘critical’ potential malicious determinations.

For example, the cloud resource analytics component 355 may initiate generation of visualizations. One visualization may be directed to a graphical visualization of cloud resources (represented as nodes) and permitted interactions (links) from the content associated with the one or more logs and/or the API events along with results of POL modeling that denote anomalous change (comparison with a baseline that normalize features, such as properties and metrics associated with the cloud resource under evaluation). Another visualization may be directed to a ranking assigned to suspicious (potentially malicious) cloud resources where higher levels of suspiciousness (or potential adverse impact if the resource is compromised) may be identified (highlighted, included within a displayable list, etc.). The cloud resource analytics component 355 is configured to further elevates priority of the cloud resource under analysis when combined with anomalous user activity context-surfacing fewer, higher-value alerts.

Upon high-confidence detection of maliciousness (e.g., ‘high’ anomaly score from the POL model(s) 332 as described below for cloud identity analysis), as a fifth operation, the cloud resource analytics component 355 may initiate signaling (e.g., one or more messages) to modules of the cyber security appliance to quarantine or disable a particular cloud resource, adjust network rules, revoke roles, or disable IAM users, with actions tailored per resource type and provider. As a result, this method delivers high-fidelity, multi-cloud detections by correlating resource-POL models anomalies, account baselines, and architecture graphs, reducing noise relative to simple create/modify alerts.

The collective operations of the cloud resource discovery component 340 and the cloud resource analytics component 355, in operations with the POL model(s) 333, provide technical advantages by enabling detection of suspicious changes to cloud resources without requiring inspection of code executing in serverless functions, and operating across major cloud providers. Also, the collective operations further reduce false positives by automated and continuous operations by AI-based POL models to detect changes to ephemeral environments, such as suspicious cloud identity manipulation (suspicious creation, modification, or assumption of a cloud identity) or suspicious cloud resource manipulation (suspicious creation or modification of a cloud resource). Where the change to the ephemeral environment is anomalous and tends to suggest maliciousness, the cloud resource analytics component 355 may signal components within the cyber security appliance (e.g., autonomous response module 440 or cyber threat analyst module 415 of FIG. 4) to quarantine or disable the newly created or modified cloud resource, adjust security groups to block access, or revoke associated permissions.

Similarly, the cloud identity discovery component 345 operates in combination with the cloud identity analytics component 350 and the POL model(s) 332. More specifically, as a first operation, the cloud identity discovery component 344 is configured to detect when cloud identities are created or current cloud identities are modified or assumed by collectively analyzing content associated with one or more logs (e.g., flow logs, management trail logs, etc.), events gathered via APIs, or the like. In general, the cloud identity discovery component 345 continuously monitors the organization cloud environment to detect identity changes (e.g., role assignments, new cloud account creation, role modifications), ensuring that any new or altered roles/accounts are promptly recognized.

After discovery of the new, modified or assumed identity, as a second operation, the cloud identity analytics component 350 is configured to gather certain properties and/or metrics associated with newly created, modified or assumed identity, where the properties and/or metrics may include the following: (1) role duration (assists in identifying short-lived roles that may indicate suspicious activity); (2) timing and location of role assumptions (assists in detecting anomalies such as roles being assumed at odd hours or from unexpected geolocations); (3) number of failed role-assumption attempts to escalate privileges relative to a user or role; (4) chaining of roles, where multiple roles are assumed in quick succession to escalate privileges; and/or (5) naming conventions to spot deviations from standard patterns.

Additionally, as a second operation, the cloud identity analytics component 350 may be configured to compute a level of permissiveness. Permissiveness is another metric that assesses the scope of actions allowed by the role, weighted by the potential risk associated with each permission. This includes evaluating whether the role permits high-risk actions like data deletion or IAM modifications. According to one embodiment of the disclosure, permissiveness may be computed as the proportion of actions permitted to a cloud identity (e.g., role) relative to all possible actions made available through this cloud identity, weighted by action type and service criticality. The POL model(s) 332 weights high-risk services such as IAM more severely, and prioritizes destructive or “write’ actions over ‘read’ actions, yielding a percentage-like score. The score currently applies per an identity (e.g., role) without recursion, but future alternatives include computing permissiveness over entire role chains. In detection, permissiveness modulates priority by highlighting unusual role assumptions that carry high potential impact, often using the maximum permissiveness across a chain for ranking. The permissiveness score acts as an input to the maliciousness component to raise or lower thresholds and rank threats relative to low-permissiveness anomalies.

Thereafter, as a third operation, the cloud identity analytics component 350 is configured to provide the collected properties and/or metrics associated with new, modified or assumed cloud identities to the POL model(s) 332. Using statistical methods and machine learning algorithms, the POL model(s) 332 conducts an analysis of the collected properties and metrics associated with the new, modified or assumed identity against established norms (baseline) to detect deviations from the norm. The POL model(s) 332 assigns an anomaly score based on the degree of deviation, with higher scores indicating a greater likelihood of malicious activity. Contextual analysis is also performed, considering the role's activity context, such as recent environmental changes or known threats, to refine the assessment.

It is noted that baselines may be established from role-specific pattern-of-life over prior days or weeks, capturing normal timing, frequency, geolocation, and usage context. For cloud resources, as described above, baselines are set at the account level (or organization/project), comparing new resource compute size, configuration parameters, and naming against historical distributions. The resource hypothesis combines a platform-specific classifier for service type with a platform-agnostic anomalous-user activity component, both using flow logs and management trail logs. Resource behavior after creation is not required; instead, the analysis focuses on POL models outliers and the creator's historical behavior to distinguish normal elasticity from threat activity. The role-assumption baseline is role-centric, while resource baselines can be flexibly computed at account, organization, or architecture scope as alternatives.

Upon receipt of the anomaly score, upon the anomaly score exceeding a certain threshold, as a fourth operation, the cloud identity analytics component 350 may signal a module within the cyber security appliance to generates alert(s) for further investigation, and high-priority anomalies may trigger automated responses. This level-based approach ensures that suspicious role activity is quickly identified and addressed, maintaining the security and integrity of the cloud environment. By analyzing these metrics and comparing them to historical norms, the cloud identity analytics component 350 and the POL model(s) 332 effectively determine roles that exhibit unusual behavior, enabling timely detection and response to potential security threats.

As a result, the cloud security system 150 reduces noise by filtering basic “unusual role/resource” alerts through a second-level investigation that fuses multiple features, surfacing only high-fidelity, high-impact incidents involving cloud identity manipulation and/or cloud resource manipulation. Multi-platform coverage uses an abstracted feature set to operate across AWS®, AZURE®, and potentially GCP®, decreasing vendor-specific engineering while maintaining detection fidelity. Role-chain and permissiveness innovations preemptively highlight impactful misuse before destructive activity, improving time-to-respond. Prioritization via centrality or embeddings focuses analyst attention on critical assets and improves user interface (UI) functionality by clustering similar architectures, enhancing triage and usability. Compared to products that only display inventories, the approach assigns meaning, risk, and priority to changes, enabling efficient Security Operations Center (SOC) workflows.

For anomalous identities, responses include revoking the assumed identity from the user or service account, restricting privileges, disabling user activity, or disabling the identity itself. For resources, inhibitors include quarantining or disabling functions and VMs, blocking access or Internet Protocol (IP) addresses, and modifying network security groups or policies per resource type. Severity is organization-tunable in cloud, allowing cautious automated interventions.

For cloud resource criticality determination, the cloud resource analytics component 355 utilizes a node centrality technique, a link count technique, or graph embedding technique to assess critical cloud resources within a cloud architecture with potential link-prediction to flag atypical connections. Embedding-based clustering can also drive UI grouping and “pivot to similar architectures,” aiding analyst navigation.

### B. Criticality Determinations for Cloud Resources

### 1. Node Centrality

According to one embodiment of the disclosure, ‘node centrality’ is a technique performed by the cloud resource analytics component 355, which is used to determine the importance and criticality of components within enumerated cloud architectures, after those architectures are constructed from cloud asset graphs. The cloud architecture graphs may be computed on a per-node centrality score used to prioritize resources.

More specifically, an architecture graph is constructed by scanning cloud accounts to enumerate assets and relationships, then traversing allowed edge types to assemble distinct architectures. In particular, the graph construction begins from common workload-bearing assets such as VPCs, VMs, and serverless functions (e.g., Lambda functions), and expands under prescribed traversal rules, with deduplication and merging to form distinct architecture groupings. This yields multiple discrete architecture subgraphs in a graph database for subsequent analysis. Edges that do not imply communication or action are excluded to prevent over-expansion of architectures.

Once architectures are available, the node centrality score is computed as a separate, post-generation operation, not embedded in the graph-building pipeline. The intent is for the cloud platform to compute and host these scores for use across products, including the cyber threat analyst module 415 of the cyber security appliance 120 of FIG. 4. More specifically, the centrality score conceptually reflects “who is connected to whom, and who connects to important nodes,” so nodes linked by other well-connected nodes score higher. This supports weighting edges, limiting to selected asset types, or tailoring to platform nuances while remaining general.

The ‘centrality’ calculation is described as computationally cheap at cloud scale, making it practical across large graphs and many architectures. This efficiency supports frequent recalculation as architectures evolve. According to one embodiment of the disclosure, the cyber threat analyst module 415 of the cyber security appliance 120 may be configured to utilize the centrality scores to rank detected cyber threats for investigation. Findings on a highly central node are prioritized for analyst attention and potential response actions.

Node centrality reduces alert fatigue by highlighting impactful nodes, enabling high-fidelity alerts in noisy cloud environments. Analysts can quickly identify high-risk assets and allocate triage time effectively. This approach supports platform-agnostic detection across AWS®, Azure®, and GCP® by using abstracted architectures, ensuring consistent risk ranking.

Centrality scores enhance user interface (UI) and workflows by filtering architectures to show only critical assets, improving navigation of large topology views. Paired with embeddings, centrality aids in clustering similar architectures, streamlining browsing and comparison.

The cloud resource analytics component 355 can integrate centrality into incident scoring, prioritizing cases involving central nodes for urgent investigation or autonomous responses. Centrality is efficiently scalable, allowing frequent updates across large node counts. Custom edge weighting or node-type scoping enables tuning to specific goals, accommodating diverse environments.

Overall, node centrality efficiently identifies critical components, driving alert prioritization and reducing noise, ensuring focus on assets with the greatest impact.

### 2. Link Prediction and Evaluation

The link prediction and evaluation technique in cloud architectures uses node embeddings derived from graph neural networks (GNNs) to estimate relationships between cloud assets. Each node, representing a cloud asset within the architecture graph, is assigned an embedding, namely a vector representation capturing the characteristics and local structure of that node. These embeddings are generated through a GNN trained using the actual architectures deployed within the organization's cloud environment.

The process involves training a model that, given two node embeddings, can determine the likelihood of a direct connection (link) between those two assets. This is done by inputting the two embeddings into the model, which outputs the probability of an edge between them. The model is trained using positive examples (pairs of assets that are connected) and negative examples (pairs that are not connected), leveraging the fact that there are typically more unconnected than connected pairs in such graphs.

Once trained, the link prediction process is applied across the cloud architecture, scoring the likelihood of each possible connection between assets. This helps identify edges and relationships that seem unusual or atypical for the organization, flagging connections that fall outside typical design specifications as compliance or design indicators. However, the approach generally does not determine maliciousness, by itself but highlights connections that warrant further analysis or confirmation from cloud administrators.

The link prediction described is a direct follow-on from the construction of node embeddings via the GNN. First, the architecture is embedded, then the embeddings are used for link prediction. This sequential usage positions link prediction as an advanced analytic layer atop the learned representation of the organization's cloud infrastructures.

In summary, the system uses GNN-produced node embeddings to represent the local context of cloud assets, and a trained model uses pairs of these embeddings to estimate the probability of relationships between them, supporting the identification of unusual or non-standard architectural links within cloud environments.

### 3. Graph Embeddings

Yet another method to determine “criticality” of cloud resources (cloud components) involves graph embeddings, which is directed to leveraging graph-based modeling and machine learning techniques to assess the importance of various nodes within a cloud architecture. This method tends to be a more advanced alternative or complementary to traditional methods like node centrality, which simply count the number of connections or apply basic graph analytics, by moving towards nuanced, machine-learned representations of complex architectures.

The graph embedding technique relies on cloud architectures represented as a graph, where the graphical nodes correspond to resources (such as virtual machines, storage buckets, or cloud services), and edges represent relationships or flows between these nodes. A graph neural network (GNN) is used to derive an “embedding,” namely a numerical, learned representation, of each node within this graph, as well as graph-level embeddings that capture the holistic context of the entire architecture. These embeddings summarize not only the node's direct connections, but also the multi-level, structural, and feature information inherent in a cloud environment.

The embedding produced by the GNN for each node can then be used to infer its criticality. For example, nodes with embeddings that cluster together may be performing similar roles or have similar importance, whereas outlier embeddings may flag components that are configured unusually or unpredictably. The process may also involve feeding these node-level embeddings into downstream models to predict which nodes are most central or essential, contributing to intelligent prioritization for alerting or investigation by security analysts.

Additionally, graph embedding allows for the comparison of individual architectures to the organization's historical patterns. By computing graph-level embeddings, the cloud resource analytics component can identify whether a newly-deployed architecture is similar or dissimilar to previous deployments, offering a compliance or anomaly detection angle; for instance, an architecture with an embedding that greatly differs from the organization's established patterns may warrant further scrutiny.

Hence, the use of graph embeddings in this context is highlighted as a sophisticated, data-driven method for understanding and managing complex cloud environments. It enables the nuanced determination and ranking of critical cloud resources, supporting both automated and human-led security operations in a dynamic infrastructure landscape.

### C. Cloud Security System—Second Embodiment

Referring now to FIG. 4, a block diagram of an exemplary embodiment of the cloud security system of FIG. 3 implemented as part of the AI-based cyber security appliance 120 is shown. The AI-based cyber security appliance 120 is configured to protect the enterprise, including but not limited to its organization cloud environments, from cyber threats. Various logic and components, such as AI-based models and modules of the cyber security appliance 120, cooperate to protect the organization cloud environment under analysis from cyber threats.

According to one embodiment of the disclosure, the AI-based cyber security appliance 120 may include a trigger module 400, a gather module 405, an analyzer module 410, a cyber threat analyst module 415, an assessment module 420, a formatting module 425, one or more AI models 430, a data store 435, an autonomous response module 440, domain module(s) 445, cloud module(s) 450, and/or a coordinator module 455. Herein, each of the AI-based models 430 may be trained with machine learning on (i) a normal pattern-of-life for one or more entities in the network/domain/cloud architectures; (ii) a normal pattern-of-life for a particular cloud identity or a particular collection of cloud identities such as pattern-of-life (POL) models directed to accounts at different user levels (individual, group of individuals, department, company, computing device, group of computing devices, etc.) and/or POL models directed to roles at different user levels (e.g., user, service, group of users, organization, company, etc.); and/or (iii) normal pattern-of-life for a particular cloud resource, and/or (iv) information associated with potential cyber threats.

Herein, the AI-based cyber security appliance 120 is configured to provide a comprehensive cloud environment security through data gathering, analytics, and actionable response operations. Within the cyber security appliance 120, the gather module 405 may be configured with both the cloud resource discovery component 340 and the cloud identity discovery component 345. The cloud resource discovery component 340 is responsible for identifying cloud resources existing within a organization cloud environment and assisting in the collection of the cloud resource information 220 (e.g., compute engines, logical data stores, firewalls, network-based resources, etc.). The collected cloud resource information 220 is provided to the data store 435 and subsequently accessed by the cloud resource analytics component 355 for collective analysis with the POL model(s) 433.

Similarly, the cloud identity discovery component 345 is tasked with identifying cloud identities existing within a organization cloud environment, notably cloud identities that may have been newly created, modified, or assumed. The cloud identity discovery component 345 is further tasked with assisting in the collection of the cloud identity information 210 for subsequent storage in the data store 435 and access by the cloud identity analytics component 350 for collective analysis with the POL model(s) 432. This cloud identity information 210 encompasses details associated with user roles for permission/privilege management, user account events such as password changes or permission modifications, or the like.

For advanced analytics, the cloud module 450 houses the cloud identity analytics component 350 and the cloud resource analytics component 355, which interact closely with AI-based pattern-of-life (POL) model(s) 432 and 433, respectively. The cloud identity analytics component 350 analyzes the collected cloud identity information 210 by generating a message for transmission to the POL model(s) 432, inclusive of all or part of the collected cloud identify information 210. The message is adapted to request the POL model(s) 432 conduct an analysis in efforts to detect and characterize anomalous or potentially malicious identity manipulations. This analysis examines properties and/or metrics associated with a cloud identity determined to have been assumed, created, or modified recently (e.g., after the last examination of the cloud architecture). The properties and/or metrics may include role duration, timing and location of access, failed or chained role-assumption attempts, and permissiveness of roles, which are correlated against baseline values formulated through statistical and machine learning techniques to assess deviation of the identity from established characteristic baselines. High-priority anomalies detected by the POL model(s) 432, signaled by significant deviation, may cause the cloud identity analytics component 350 to initiate alert(s) or automated response(s) to maintain cloud environment security.

Concurrently, the cloud resource analytics component 355 is configured to perform analytics on properties and/or metrics associated with a newly created or modified cloud resource, where correlations between the values of these properties and/or metrics to POL model baselines may be utilized to assess the likelihood of this cloud resource being anomalous or malicious. The analytics may include evaluation of resource compute size, configuration, type, lifecycle dynamics, location, and naming patterns. The cloud resource analytics component 355 is further configured to filter out noise from outlier values consistent with typical resource development, and prioritize the display and triage of critical cloud resources using advanced techniques such as node centrality, link prediction, and graph embeddings—allowing effective detection of high-risk assets and focused alerting for response by security analysts.

By combining detailed discovery (in the gather module 405) and advanced analytics (in the cloud module 450), the cyber security appliance 120 provides robust security posture management, real-time threat detection, and flexible integration for automated and human-led incident response across diverse and complex cloud architectures.

More specifically, according to one embodiment of the disclosure, the cyber security appliance 120 is configured to protect cloud identities and cloud resources (cloud components) associated with a cloud environment. As shown, the gather module 405 may be configured with the cloud resource discovery component 340 and the cloud identity discovery component 345, which are adapted to retrieve the cloud resource information 220 and cloud identity information 210 from the organization cloud environment via I/O ports 460. The data store 435 may be configured to cooperate with the gather module 405 to collect and maintain historical data of properties and/or metrics associated with cloud resources and historical data of properties and/or metrics associated with cloud identities.

The analyzer module 410 may be configured to cooperate with AI model(s) 430 or other modules in the cyber security appliance 120 to confirm a presence of a cyber threat directed to cloud identity manipulation and/or cloud resource manipulation. A cyber threat analyst module 415 may be further configured to cooperate with the AI model(s) 430 and/or other modules in the cyber security appliance 120 to conduct a long-term investigation and/or a more in-depth investigation on potential cyber threats attacking domain(s) and/or cloud environment. An algorithm in the analyzer module 410 can cooperate with the gather module 405 to collect any additional data (e.g., properties and/or metrics) to support a possible cyber threat hypothesis. The analyzer module 410 and/or the cyber threat analyst module 415 can also look for other anomalies, such as model breaches, including, for example, deviations for a normal behavior associated with the creation, modification or assumption of user roles or user accounts (cloud identities), creation or modification of cloud resources, or the like. The analyzer module 410 and/or the cyber threat analyst module 415 can cooperate with the AI models 430 trained on potential cyber threats in order to assist in examining and factoring these additional data points that have occurred over a given timeframe to see if a correlation exists between 1) a series of two or more anomalies occurring within that time frame and 2) possible known and unknown cyber threats. The cyber threat analyst module 415 can cooperate with the internal data sources as well as external data sources to collect data in its investigation.

The cyber threat analyst module 415 in essence allows two levels of investigations of potential cyber threat attacks. In a first level, the analyzer module 410 and AI models 430 can rapidly detect and then autonomously respond to overt and obvious cyber threats. However, many low level anomalies occur in a cloud environment (e.g., cloud identity creation, modification or assumption; cloud resource creation or modification), and thus, most other systems need to set the threshold of trying to detect a cyber threat at level higher than the low level anomalies examined by the cyber threat analyst module 415 just to not have too many false positive indications of a cyberattack when one is not actually occurring, as well as to not overwhelm a human cyber analyst receiving the alerts with so many notifications of low level anomalies that they just start tuning out those alerts. Herein, the cyber threat analyst module 415 conducts investigations over time that can detect these advanced persistent cyber threats actively trying to avoid detection by looking at one or more of these low-level anomalies as a part of a chain of linked information.

The cyber threat analyst module 415 is configured to form and investigate hypotheses on what are a possible set of cyber threats and can also cooperate with the analyzer module 410 with its one or more data analysis processes to conduct an investigation on a possible set of cyber threats hypotheses that would include an anomaly of at least one of i) the abnormal behavior, ii) the suspicious activity, and iii) any combination of both, identified through cooperation with, for example, the AI model(s) 430 trained with machine learning on the normal pattern-of-life of entities in the system. The cyber threat analyst module 415 may be configured to submit to check and recheck various combinations/a chain of potentially related information under analysis until each of the one or more hypotheses on potential cyber threats are one of 1) refuted, 2) supported, or 3) included in a report that includes details of activities assessed to be relevant activities to the anomaly of interest to the user and that also conveys at least this particular hypothesis was neither supported or refuted; and thus, needs a human to further investigate the anomaly of interest included in the chain of potentially related information.

It is contemplated that a data analysis process or any analytics can be conducted by algorithms/scripts to perform their function discussed herein; and can in various cases use AI classifiers as part of their operation. It is further contemplated that any portions of the AI-based cyber security appliance 120 or the cloud security system 150, when implemented as software, can be stored in one or more non-transitory memory storage devices in an executable format to be executed by one or more processors.

As a starting point, the AI-based cyber security appliance 120 can use the trigger module 400 working with the AI model(s) 430 of the normal pattern-of-life for the entities in the network/domain or the cloud resources or cloud architectures in the cloud environment under analysis to identify abnormal behavior and/or suspicious activity compared to the normal behavior of that entity, which is supplied to the analyzer module 410 and/or the cyber threat analyst module 415. The analyzer module 410 and/or the cyber threat analyst module 415 may also receive other inputs such as AI model breaches, AI classifier breaches, etc. Note, the trigger module 400 can also receive a trigger to start an investigation from an external source.

Referring still to FIG. 4, the autonomous response module 440 is configured to take one or more autonomous mitigation actions to mitigate the cyber threat during the cyberattack. The autonomous response module 440 can reference an AI model trained to track a normal pattern-of-life for each cloud resource and/or its cloud architecture itself to perform an autonomous act of, for example, restricting a potentially compromised cloud identity, cloud resource or cloud architecture having i) an actual indication of compromise (e.g., determination of suspiciousness or maliciousness) to merely take actions that are within that resource's or cloud architecture's normal pattern-of-life to mitigate the cyber threat.

The chain of the individual alerts, activities, and events that form the pattern including one or more unusual or suspicious activities into a distinct item for cyber threat analysis of that chain of distinct alerts, activities, and/or events. The cyber threat analyst module 415 may reference the one or more machine learning models trained on, in this example, cloud architecture threats to identify similar characteristics from the individual alerts and/or events forming the distinct item made up of the chain of alerts and/or events forming the unusual pattern. In the next step, the assessment module 420 with the AI classifiers, once armed with the knowledge that malicious activity is likely occurring/is associated with a given process from the analyzer module 410, then cooperates with the autonomous response module 440 to take an autonomous action such as i) deny access in or out of the cloud identity or cloud resource, (ii) shutdown activities involving a detected malicious cloud identity/resource, (iii) restrict cloud resources and/or users to merely operate within their particular normal pattern-of-life, (iv) adjust identity role such as remove some user privileges/permissions associated with the compromised cloud role or cloud account, and/or (v) conduct offensive countermeasures to disable operations of a malicious computing device associated with the malicious cloud identity or cloud resource.

The autonomous response module 440, rather than a human taking an action, can be configured to cause one or more rapid autonomous actions in response to be taken to counter the cyber threat, which may include disabling a source of the cyber threat (e.g., malicious server(s)). The disabling or restricting operability of the malicious cloud identity or cloud resource may be accomplished by disabling its ability to communicate with users and/or targeted systems.

Herein, the cyber security appliance 120 is configured for an architecture-based approach to cloud security.

### V. Exemplary Network System & Computing Devices

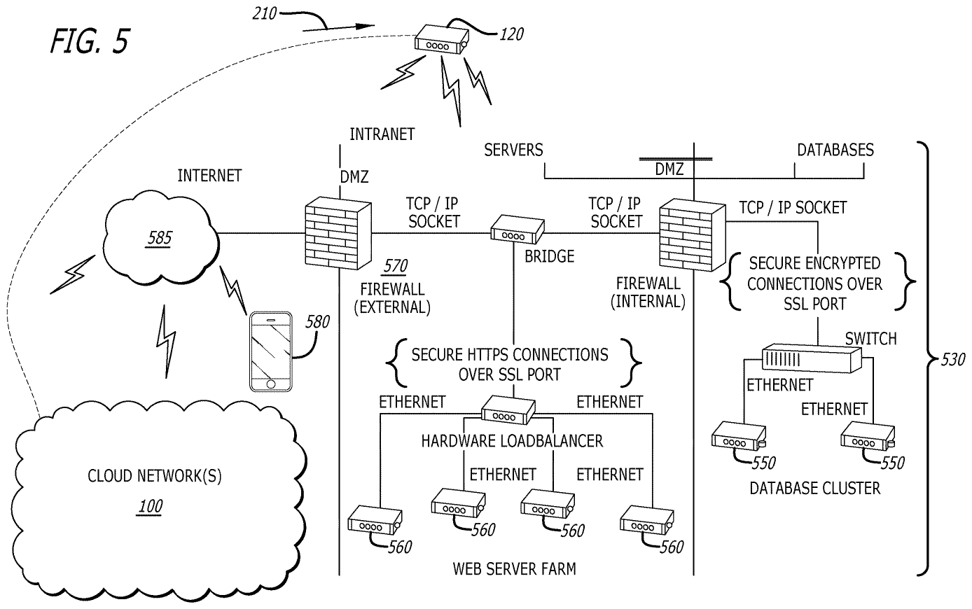

Referring to FIG. 5, an embodiment of the cyber security appliance 120 plugging in as an appliance platform to protect a system is shown. The cyber security appliance 120 is part of an enterprise network 530, which may further include one or more computing devices such as database servers 550, web servers 560, networking devices 570 (e.g., bridge, switch, router, load-balancers, gateways, and/or firewalls), consumer electronic devices 580 with connectivity to resources within the enterprise network 530 as well as a publicly accessible network 585 (e.g., the Internet). The consumer electronic devices 580 may include, but are not limited or restricted to desktop computers, laptops, smart phones, tablets, wearables, smart appliances, or the like.

The cloud identity discovery component 345 and the cloud identity analytics component 350 may be deployed as part of the cyber security appliance 120 to collect cloud identity information 210 from the organization cloud environment within the cloud network and to conduct subsequent analytics to determine whether the cloud identity is suspicious (potentially malicious) to warrant alerts to an administrator via one or more of the electronic devices 580 or via one of the web servers 560. Additionally, the cloud resource discovery component 340 and the cloud resource analytics component 355 may be deployed as part of the cyber security appliance 120 to collect cloud resource information 220 from the organization cloud environment within the cloud network 100 and to conduct subsequent analytics to determine whether the cloud resource is suspicious (potentially malicious) to warrant another alert to an administrator via one or more of the electronic devices 580 or via one of the web servers 560. These operations may be performed sequentially or concurrently (overlapping at least a portion in time).

The methods and systems shown in the Figures and discussed in the text herein can be coded to be performed, at least in part, by one or more processing components with any portions of software stored in an executable format on a computer readable medium. Thus, any portions of the method, apparatus and system implemented as software can be stored in one or more non-transitory storage devices in an executable format to be executed by one or more processors. The non-transitory storage devices could be, for example, a physical computer readable storage medium such as semiconductor memory or solid-state memory, or the like.

The various methods described above may also be implemented by a computer program product. The computer program product may include computer code arranged to instruct a computer to perform the functions of one or more of the various methods described above. The computer program and/or the code for performing such methods may be provided to an apparatus, such as a computer, on a computer readable medium or computer program product.

A computing device can be, wholly or partially, part of one or more of the server or client computing devices in accordance with some embodiments. Components of the computing device can include, but are not limited to, a processing unit having one or more processing cores, a system memory, and a system bus that couples various system components including the system memory to the processing unit.

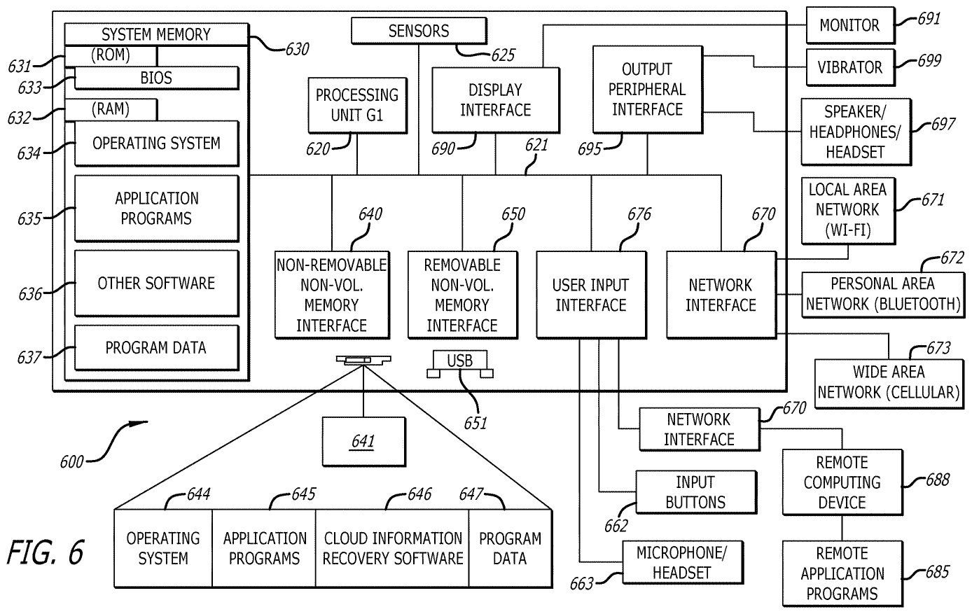

Referring now to FIG. 6, a block diagram of an embodiment of an exemplary computing device 600, which may be implemented to operate as the cyber security appliance 120, is shown. The computing device 600 may include one or more processors or processing units 620 to execute instructions, one or more memories 630-632 to store information, one or more data input components 660-663 to receive data input from a user of the computing device 600, and one or more modules that feature and support operability of the cloud resource discovery component 340, the cloud identity discovery component 345, the cloud identity analytics component 350, and the cloud resource analytics component 355 described above. Additionally, the computing device 600 may include a network interface (communication circuit) 670 to establish a communication link to communicate with other computing devices external to the computing device, one or more sensors where an output from the sensors is used for sensing a specific triggering condition and then correspondingly generating one or more preprogrammed actions, a display monitor 691 to display at least some of the information stored in the one or more memories 630-632 and other components. Note, portions of this design implemented in software 644-646, including sensors configured to establish and support recovery of traffic data, log data, cloud identity information, and/or cloud resource information (e.g., audit sensor, container sensor, c-sensor(s), v-sensor(s)), are stored in the one or more memories 630-632 and are executed by the processing unit 620.

As further shown in FIG. 6, the processing unit 620 may have one or more processing cores, which couples to a system bus 621 that couples various system components, which may include the system memory 630 and/or any physical sensors 625 utilized by Kubernetes clusters in lieu of the logical sensors controlled through cloud information recovery software 646 (which may include discovery components 340/345). The system bus 621 may be any of several types of bus structures selected from a memory bus, an interconnect fabric, a peripheral bus, and a local bus using any of a variety of bus architectures.

Computing device 600 typically includes a variety of non-transitory storage medium. The non-transitory storage medium can be any available media that can be accessed by computing device 600 and includes both volatile and nonvolatile media, and removable and non-removable media. By way of example, and not limitation, the non-transitory storage medium is adapted for storage of information, such as computer-readable instructions, data structures, executable software, pattern-of-life models, or other data. In an example, a volatile memory drive 641 is illustrated for storing portions of the operating system 644, application programs 645, cloud information recovery software 646, and program data 647.

The non-transitory storage medium includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other tangible medium which can be used to store the desired information, and which can be accessed by the computing device 600. Transitory storage medium such as wireless channels are not included in the non-transitory storage medium.

A user may enter commands and information into the computing device 600 through input devices such as a keyboard, touchscreen, or software or hardware input buttons 662, a microphone 663, a pointing device and/or scrolling input component, such as a mouse, trackball, or touch pad 661. The microphone 663 can cooperate with speech recognition software. These and other input devices are often connected to the processing unit 620 through a user input interface 660 that is coupled to the system bus 621, but can be connected by other interface and bus structures, such as a lighting port, game port, or a universal serial bus (USB). A display monitor 691 or other type of display screen device is also connected to the system bus 621 via an interface, such as a display interface 690. In addition to the monitor 691, computing devices may also include other peripheral output devices such as speakers 697, a vibration device 699, and other output devices, which may be connected through an output peripheral interface 695.

The computing device 600 can operate in a networked environment using logical connections to one or more remote computing devices/client devices, such as a remote computing device 680. The remote computing device 680 can a personal computer, a mobile computing device, a server, a router, a network PC, a peer device, or other common network node, and typically includes many or all of the elements described above relative to the computing device 600. The logical connections can include a personal area network (PAN) 672 (e.g., Bluetooth®), a local area network (LAN) 671 (e.g., Wi-Fi), and a wide area network (WAN) 673 (e.g., cellular network). Such networking environments are commonplace in offices, enterprise-wide computer networks, intranets, and the Internet. A browser application and/or one or more local apps may be resident on the computing device and stored in the memory.

When used in a LAN networking environment, the computing device 600 is connected to the LAN 671 through the network interface 670, which can be, for example, a Bluetooth® or Wi-Fi adapter. When used in a WAN networking environment (e.g., Internet), the computing device 600 typically includes some means for establishing communications over the WAN 673. With respect to mobile telecommunication technologies, for example, a radio interface, which can be internal or external, can be connected to the system bus 621 via the network interface 670, or other appropriate mechanism. In a networked environment, other software depicted relative to the computing device 600, or portions thereof, may be stored in the remote memory storage device. By way of example, and not limitation, remote application programs 685 as reside on remote computing device 680. It will be appreciated that the network connections shown are examples and other means of establishing a communications link between the computing devices that may be used. It should be noted that the present design can be conducted on a single computing device or on a distributed system in which different portions of the present design are conducted on different parts of the distributed computing system.

Note, an application described herein includes but is not limited to software applications, mobile applications, and programs routines, objects, widgets, plug-ins that are part of an operating system application. Some portions of this description are presented in terms of algorithms and symbolic representations of operations on data bits within a non-transitory storage medium. These algorithmic descriptions and representations are the means used by those skilled in the data processing arts to effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like. These algorithms can be written in a number of different software programming languages such as Python, C, C++, Java, HTTP, or other similar languages. Also, an algorithm can be implemented with lines of code in software, configured logic gates in hardware, or a combination of both. In an embodiment, the logic consists of electronic circuits that follow the rules of Boolean Logic, software that contain patterns of instructions, or any combination of both. A module may be implemented in hardware electronic components, software components, and a combination of both. A software engine is a core component of a complex system consisting of hardware and software that is capable of performing its function discretely from other portions of the entire complex system but designed to interact with the other portions of the entire complex system.

Unless specifically stated otherwise as apparent from the above discussions, it is appreciated that throughout the description, discussions utilizing terms such as “processing” or “computing” or “calculating” or “determining” or “displaying” or the like, refer to the action and processes of a computer or other electronic computing device, that manipulates and transforms data represented as physical (electronic) quantities within the computing device's registers and memories into other data similarly represented as physical quantities within the computing device memories or registers, or other such information storage, transmission or display devices.

### Training of AI Pre-Deployment and Then During Deployment

In step 1, an initial training of the Artificial Intelligence-based (AI-based) model trained on cyber threats can occur using unsupervised learning and/or supervised learning on characteristics and attributes of known potential cyber threats including malware, insider threats, and other kinds of cyber threats that can occur within that domain. Each Artificial Intelligence can be programmed and configured with the background information to understand and handle particulars, including different types of data, protocols used, types of devices, user accounts, etc. of the system being protected. The Artificial Intelligence pre-deployment can all be trained on the specific machine learning task that they will perform when put into deployment. For example, one or more AI-based POL models (hereinafter “AI-based model(s) 155”), trained on identifying a specific cyber threat learns at least both in the pre-deployment training i) the characteristics and attributes of known potential cyber threats as well as ii) a set of characteristics and attributes of each category of potential cyber threats and their weights assigned on how indicative certain characteristics and attributes correlate to potential cyber threats of that category of threats. In this example, one of the AI model(s) 155 trained on identifying a specific cyber threat can be trained with machine learning such as Linear Regression, Regression Trees, Non-Linear Regression, Bayesian Linear Regression, Deep learning, etc. to learn and understand the characteristics and attributes in that category of cyber threats. Later, when in deployment in a domain/network being protected by the cyber security appliance 120, the AI model trained on cyber threats can determine whether a potentially unknown threat has been detected via a number of techniques including an overlap of some of the same characteristics and attributes in that category of cyber threats. The AI model may use unsupervised learning when deployed to better learn newer and updated characteristics of cyberattacks.

In an embodiment, one or more of the AI-based POL models 155 (332/333, 432/433) may be trained on a normal pattern-of-life of entities in the system are self-learning AI model using unsupervised machine learning and machine learning algorithms to analyze patterns and ‘learn’ what is the ‘normal behavior’ of the network by analyzing data on the activity on, for example, the network level, at the device level, and at the employee level. The self-learning AI model using unsupervised machine learning understands the system under analysis' normal patterns of life in, for example, a week of being deployed on that system, and grows more bespoke with every passing minute. The AI unsupervised learning model learns patterns from the features in the day-to-day dataset and detecting abnormal data which would not have fallen into the category (cluster) of normal behavior. The self-learning AI model using unsupervised machine learning can simply be placed into an observation mode for an initial week or two when first deployed on a network/domain in order to establish an initial normal behavior for entities in the network/domain under analysis.

Thus, a deployed AI-based POL model(s) 155 trained on a normal behavior of entities in the system can be configured to observe the nodes in the system being protected. Training on a normal behavior of entities in the system can occur while monitoring for the first week or two until enough data has been observed to establish a statistically reliable set of normal operations for each node (e.g., user account, device, etc.). Initial training of the AI-based POL model(s) 155 trained with machine learning on a normal behavior of the pattern-of-life of the entities in the network/domain can occur where each type of network and/or domain will generally have some common typical behavior with each model trained specifically to understand components/devices, protocols, activity level, etc. to that type of network/system/domain. Alternatively, pre-deployment machine learning training of the AI-based POL model(s) trained on a normal pattern-of-life (POL) of entities in the system can occur. Initial training of the AI-based POL model(s), which trained with machine learning on a behavior of the pattern-of-life of the entities in the network/domain can occur where each type of network and/or domain will generally have some common typical behavior with each model trained specifically to understand components/devices, protocols, activity level, etc. to that type of network/system/domain. What is normal behavior of each entity within that system can be established either prior to deployment and then adjusted during deployment or alternatively the model can simply be placed into an observation mode for an initial week or two when first deployed on a network/domain in order to establish an initial normal behavior for entities in the network/domain under analysis. During deployment, what is considered normal behavior will change as each different entity's behavior changes and will be reflected through the use of unsupervised learning in the model such as various Bayesian techniques, clustering, etc. The AI-based POL models 155 can be implemented with various mechanisms such neural networks, decision trees, etc. and combinations of these. Likewise, one or more supervised machine learning AI-based POL models 155 may be trained to create possible hypotheses and perform cyber threat investigations on agnostic examples of past historical incidents of detecting a multitude of possible types of cyber threat hypotheses previously analyzed by human cyber security analyst. More on the training of AI-based POL models 155 are trained to create one or more possible hypotheses and perform cyber threat investigations will be discussed later.

At their core, the self-learning AI-based POL model(s) 155 that model the normal behavior (e.g. a normal pattern-of-life) of entities in the network mathematically characterizes what constitutes ‘normal’ behavior, based on the analysis of a large number of different measures of a device's network behavior—packet traffic and network activity/processes including server access, data volumes, timings of events, credential use, connection type, volume, and directionality of, for example, uploads/downloads into the network, file type, packet intention, admin activity, resource and information requests, command sent, etc.

The methods, apparatuses, and systems shown in the Figures and discussed in the text herein can be coded to be performed, at least in part, by one or more processing components with any portions of software stored in an executable format on a non-transitory storage medium. Thus, any portions of the method, apparatus and system implemented as software can be stored in one or more non-transitory storage mediums in an executable format to be executed by one or more processors. The storage medium may be non-transitory and does not include radio or other carrier waves. The storage medium could be, for example, a physical computer readable medium such as semiconductor memory or solid-state memory, magnetic tape, a removable computer diskette, a random-access memory (RAM), a read-only memory (ROM), a rigid magnetic disc, and an optical disk, such as a CD-ROM, CD-R/W or DVD. The various methods described above may also be implemented by a computer program product. The computer program product may include computer code arranged to instruct a computer to perform the functions of one or more of the various methods described above. The computer program and/or the code for performing such methods may be provided to an apparatus, such as a computer, on a computer readable medium or computer program product. For the computer program product, a transitory computer readable medium may include radio or other carrier waves.

Note, an application described herein includes but is not limited to software applications, mobile applications, and programs routines, objects, widgets, plug-ins that are part of an operating system application. Some portions of this description are presented in terms of algorithms and symbolic representations of operations on data bits within a non-transitory storage medium. These algorithmic descriptions and representations are the means used by those skilled in the data processing arts to convey the substance of their work most effectively to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like. These algorithms can be written in a number of different software programming languages such as Python, C, C++, Java, HTTP, or other similar languages. Also, an algorithm can be implemented with lines of code in software, configured logic gates in hardware, or a combination of both. In an embodiment, the logic consists of electronic circuits that follow the rules of Boolean Logic, software that contain patterns of instructions, or any combination of both. A module or other component may be implemented in hardware electronic components, software components, and a combination of both. Likewise, a component may be implemented in hardware electronic circuits, software components, and a combination of both. A software engine is a core component of a complex system consisting of hardware and software that is capable of performing its function discretely from other portions of the entire complex system but designed to interact with the other portions of the entire complex system.

Unless specifically stated otherwise as apparent from the above discussions, it is appreciated that throughout the description, discussions utilizing terms such as “processing” or “computing” or “calculating” or “determining” or “displaying” or the like, refer to the action and processes of a system or computing device, or similar electronic computing device, that manipulates and transforms data represented as physical (electronic) quantities within the computing device's registers and memories into other data similarly represented as physical quantities within the computing device memories or registers, or other such information storage, transmission or display devices.

While the foregoing design and embodiments thereof have been provided in considerable detail, it is not the intention of the applicant(s) for the design and embodiments provided herein to be limiting. Additional adaptations and/or modifications are possible, and, in broader aspects, these adaptations and/or modifications are also encompassed. Accordingly, departures may be made from the foregoing design and embodiments without departing from the scope afforded by the following claims, which scope is only limited by the claims when appropriately construed.

What is claimed is:

1. An enterprise security system, comprising:
a cloud security system configured to collect information associated with at least a cloud resource to (i) determine whether the cloud resource has been created or modified within a prescribed period of time from a time of collection, and if so, (ii) provide one or more portions of the information to at least a first pattern-of-life model configured to conduct an analysis as to whether the one or more portions of the information deviate from a baseline of normal characteristics associated with a first cloud resource of similar type, and (iii) receive results of the analysis by at least the first pattern-of-life model to classify the cloud resource as malicious based on deviations from the baseline of normal characteristics;
an output system communicatively coupled to the cloud security system, wherein the output system is configured to generate a graphical representation of a cloud architecture including the cloud resource with an identification that the cloud resource is potentially malicious; and
wherein the cloud security system and the output system are implemented in i) hardware electronic components, ii) software stored on one or more non-transitory storage medium and executed by one or more processors, and a combination of both i) and ii).

2. The enterprise security system of claim 1, wherein the cloud security system is further configured to collect the information associated with at least a cloud identity to (i) determine whether the cloud identity has been created or modified within the prescribed period of time from the time of collection or has assumed privileges and permissions assigned to the cloud identity within the prescribed period of time from the time of collection, and if so, (ii) provide at least a portion of the information associated with the cloud identity to at least a second pattern-of-life model configured to conduct an analysis as to whether the portion of the information deviates from a baseline of normal identity characteristics associated with a cloud identity of similar type, and (iii) receive results of the analysis by the second pattern-of-life model to classify the cloud identity as malicious based on deviations from the baseline of normal characteristics associated with the cloud identity of similar type.

3. The enterprise security system of claim 1, wherein the cloud security system comprises (i) a cloud resource discovery component configured to determine a plurality of cloud resources including the cloud resource within an organization's cloud environment under analysis and collect the information including properties and/or metrics directed to the cloud resource, and (ii) a cloud resource analytics component configured to determine whether any of the plurality of cloud resources, including the cloud resource, has been created or modified within the prescribed period of time and determine whether the cloud resource is malicious based on the analysis results from at least the first pattern-of-life model.

4. The enterprise security system of claim 3, wherein the properties and/or metrics directed to the cloud resource comprises two or more of (1) resource compute size or capacity, (2) resource configuration, (3) resource type, (4) resource naming convention, (5) ephemeral resource lifecycles including spin-up frequency and duration, and/or (6) resource location.

5. The enterprise security system of claim 2, wherein the cloud security system comprises (i) a cloud identity discovery component configured to determine a plurality of cloud identities including the cloud identity operating within an organization's cloud environment under analysis and collect the information including properties and/or metrics directed to the cloud identity, and (ii) a cloud identity analytics component configured to determine whether any of the plurality of cloud identities, including the cloud identity, has been created, modified or assumed within the prescribed period of time and determine whether the cloud identity is malicious based on the analysis results from at least the second pattern-of-life model.

6. The enterprise security system of claim 5, wherein the properties and/or metrics directed to a cloud role being the cloud identity that comprises two or more of (1) a duration of the role, (2) a number of role change attempts, (3) a number of failed roll change attempts to escalate privileges relative to a user, and (4) a time of an activity to attempt the role change.

7. The enterprise security system of claim 2, further comprising:
a cyber security appliance including a plurality of pattern-of-life models including the first pattern-of-life model and the second pattern-of-life model and an autonomous response module, wherein the autonomous response module is configured to perform an autonomous act in response to the cloud identity or the cloud resource deemed to be malicious by at least (i) denying access in or out of the cloud identity or cloud resource, (ii) shutting down activities involving the cloud identity or the cloud resource, (iii) restricting the cloud resource or a user of the cloud resource to merely operate within a particular normal pattern-of-life, or (iv) adjusting a role or a cloud account being the cloud identity by removing one or more user privileges or permissions associated with the role or cloud account.

8. A cloud security system for providing comprehensive visibility and an in-depth understanding of a cloud environment, including creation or changes to cloud identities and cloud resources within the cloud environment, the cloud security system comprising:
a cloud resource discovery component configured to determine a plurality of cloud resources including a cloud resource within an organization's cloud environment under analysis and collect information including properties and/or metrics directed to the cloud resource;
a cloud resource analytics component configured to (i) determine whether any of the plurality of cloud resources, including the cloud resource, has been created or modified within a prescribed period of time from a time of collection of the properties and/or metrics directed to the cloud resource, and if so, (ii) provide one or more portions of the information to at least a first pattern-of-life model configured to conduct an analysis as to whether the one or more portions of the information deviate from a baseline of normal characteristics associated with a first cloud resource of a type similar to the cloud resource, and (iii) receive results of the analysis by at least the first pattern-of-life model to classify the cloud resource as malicious based on deviations from the baseline of normal characteristics; and
wherein the cloud resource analytics component and the cloud resource discovery component are implemented in i) hardware electronic components, ii) software stored on one or more non-transitory storage medium and executed by one or more processors, and a combination of both i) and ii).

9. The cloud security system of claim 8 further comprising:
a cloud identity discovery component configured to determine a plurality of cloud identities including the cloud identity operating within the organization's cloud environment under analysis and collect the information including properties and/or metrics directed to the cloud identity; and
a cloud identity analytics component configured to determine whether any of the plurality of cloud identities, including the cloud identity, has been created, modified, or assumed within the prescribed period of time and determine whether the cloud identity is malicious based on the analysis results from at least a second pattern-of-life model.

10. The cloud security system of claim 9, wherein the properties and/or metrics directed to the cloud resource comprise (1) resource compute size or capacity, (2) resource configuration, and (3) resource type.

11. The cloud security system of claim 9, wherein the properties or metrics directed to the cloud resource comprise a resource naming convention.

12. The cloud security system of claim 9, wherein the properties or metrics directed to the cloud resource comprises an ephemeral resource lifecycle including spin-up frequency, duration, and timing of activation.

13. The cloud security system of claim 9, wherein the properties and/or metrics directed to the cloud identity being a cloud role comprises (1) a number of role change successfully attempted and (2) a duration of the role.

14. The cloud security system of claim 9, wherein the properties and/or metrics directed to the cloud identity being a cloud role comprises (1) a number of roll change attempts, (2) a number of failed roll change attempts to escalate privileges relative to a user, and (3) a time of activity of the role change attempts.

15. The cloud security system of claim 9 being in communication with a cyber security appliance including a plurality of pattern-of-life models including the first pattern-of-life model and the second pattern-of-life model, wherein the cyber security appliance further comprises an autonomous response module configured to perform an autonomous act in response to the cloud identity or the cloud resource deemed to be malicious by at least (i) denying access in or out of the cloud identity or cloud resource, (ii) shutting down activities involving the cloud identity or the cloud resource, (iii) restricting the cloud resource or a user of the cloud resource to merely operate within a particular normal pattern-of-life, or (iv) adjusting a role or a cloud account being the cloud identity by removing one or more user privileges or permissions associated with the role or cloud account.

16. The cloud security system of claim 9, wherein the cloud resource analytics component includes a node centrality module that, when in operation, (i) generates a graphical representation of nodes beginning with one or more workload-bearing assets to formulate architecture groupings and (ii) determines a centrality score for each node based in part on ingress and egress connectivity associated with that node.

17. The cloud security system of claim 9, wherein the cloud resource analytics component includes a link prediction and evaluation module that leverages a graph neural network trained on cloud architectures and operates to predict links associated with graphical nodes created in a graphical representation produced by an output system communicatively coupled to the cloud security system.

18. The cloud security system of claim 9, wherein the cloud identity analytics component includes a graph embedding module configured to extract graph level embeddings for each node of a graphical representation of the cloud environment generated in part by the cloud security system to determine similarities between nodes for clustering similar nodes to visualize how the cloud environment is organized.

19. The cloud security system of claim 9, wherein the cloud identity analytics component is communicatively coupled to a permissiveness module that is configured to compute a permissiveness score associated with a role being a cloud identity, wherein the permissiveness score is determined from an analysis of (i) permitted actions available to a user assuming the role and (ii) a total number of possible actions available for the role and a weight applied to each action based on a relative amount of effect on the cloud environment caused by the action.

20. A computerized method performed by execution of one or more instructions by one or more processors in which the one or more instructions are stored in a non-transitory storage medium, the computerized method comprising:
collecting content associated with one or more cloud identities undergoing creation, modification, or assumption within a prescribed period of time prior to the collecting of the content in order to detect identity changes thereby ensuring that any new or altered cloud identities are promptly recognized;
gathering certain properties and metrics associated with one or more cloud roles corresponding to the one or more cloud identities, including a plurality of (1) role duration; (2) timing and location of role assumptions; (3) number of failed role-assumption attempts to escalate privileges relative to a user or role; (4) chaining of roles, where multiple roles are assumed in quick succession to escalate privileges; or (5) naming conventions to spot deviations from standard patterns;
computing a level of permissiveness being a metric that assesses a scope of actions allowed by the one or more cloud roles, weighted by potential risk associated with each permission;
providing the certain properties and metrics associated with a cloud role of the one or more cloud roles to at least a first pattern-of-life model modeling a type of cloud role identical to the cloud role, wherein the first pattern-of-life model using statistical methods and machine learning algorithms to conduct an analysis of the certain properties and metrics against an established baseline of characteristics of the type of cloud role identical to the cloud role to detect deviations from the baseline and assign an anomaly score based on a degree of deviation, with higher scores indicating a greater likelihood of malicious activity; and
based on the cloud role assigned the anomaly score identifying the malicious activity exceeding a prescribed threshold, generating an alert to identify the cloud role is malicious and trigger an automated response to alter permissions or privileges associated with the cloud role.

21. The computerized method of claim 20 further comprising:
collecting content associated with one or more cloud resources are created or existing cloud resources are modified;
gathering certain properties and metrics associated with a cloud resource of the one or more cloud resources that has been newly created or modified, where the properties and metrics include a plurality of: (i) compute or memory size of the cloud resource, (ii) naming convention for the cloud resource, and (iii) timing in creation or modification of the cloud resource;
providing the certain properties and metrics associated with the cloud resource of the one or more cloud resources to at least a second pattern-of-life model modeling a type of cloud resource identical to the cloud resource, wherein the second pattern-of-life model using statistical methods and machine learning algorithms to conduct an analysis of the certain properties and metrics associated with the cloud resource against an established baseline of characteristics of the type of cloud resource identical to the cloud resource to detect deviations from the baseline and assign a second anomaly score based on the degree of deviation, with higher scores indicating a greater likelihood of the malicious activity; and
based on the cloud resource assigned the second anomaly score identifying a malicious activity exceeding a prescribed threshold, generating an alert to identify the cloud resource is malicious and trigger an automated response to alter operability of the cloud resource.
